(19) United States
(12) Patent Application Publication
(10) Pub. No.: US 2010/0111432 A1
(43) Pub. Date: May 6, 2010

(54) Device and Method for Coding a Transformation Coefficient Block

(76) Inventor: Joerg Mohr, Schwabach (DE)

Correspondence Address: GLENN PATENT GROUP, 3475 EDISON WAY, SUITE L, MENLO PARK, CA, 94025, US

(21) Appl. No.: 12/521,276

(22) PCT Filed: Dec. 10, 2007
(86) PCT No.: PCT/EP07/10756

§ 371 Date: Jan. 12, 2010

(30) Foreign Application Priority Data
Dec. 27, 2006 (DE) 10 2006 061 647.2
Dec. 27, 2006 (DE) 10 2006 061 648.0
Dec. 27, 2006 (DE) 10 2006 061 651.0

(51) Int. Cl. G06K 9/36

(52) U.S. Cl. 382/247

(57) ABSTRACT

A coding of a block of transformation coefficients wherein a precoder traverses the magnitude bits of a predetermined one of magnitude bit planes in tuples of a plurality of adjacent magnitude bits, and codes predetermined ones of the magnitude bits of the tuples into data words such that a predetermined magnitude bit is coded along with an associated sign bit into one of the data words, or that a predetermined magnitude bit is coded along with any other predetermined magnitude bit of the same tuple, into one of the data words. A data word buffer temporarily stores the data words and an entropy coder codes the data words from the data word buffer into a coded data stream. Alternative coding aspects are also presented. According to one alternative aspect, a running window buffer is filled with status bits while traversing the coefficients.

### CROSS-REFERENCE TO RELATED APPLICATIONS

This application is a U.S. national entry of PCT Patent Application Serial No. PCT/EP2007/010756 filed 10 Dec. 2007, and claims priority to German Patent Application No. 102006061648.0-31 filed on 27 Dec. 2006, German Patent Application No. 102006061647.2 filed 27 Dec. 2006, and German Patent Application No. 102006061651.0 filed 27 Dec. 2006, which are incorporated herein by references in their entirety.

### BACKGROUND OF THE INVENTION

1. Field of the Invention

The present invention relates to coding transformation coefficient blocks, such as an image, as occurs, for example, in the course of the digital image compression technique in accordance with the JPEG2000 standard.

2. Description of the Related Art

The steps of the JPEG2000 coding process comprise optional subdivision of the image into so-called tiles, i.e. rectangular image areas, a DC signal portion level shift, optional transformation of the color components, performing a discrete wavelet transformation, scalar quantization of the wavelet coefficients, arranging the quantized wavelet coefficients in two-dimensional arrays, so-called “code blocks”, block coding which comprises a so-called “coefficient bit modeling process”, and an arithmetic coding process as well as arranging the coded code block data into a coding stream which conforms to standard. The steps are described, for example, in Christopoulos et al.: The JPEG2000 Still Image Coding System: An Overview, IEEE Transactions on Consumer Electronics, Vol. 46, No. 4, pp. 1103-1127, November 2000.

Among said steps, the computationally most intensive part is coefficient bit modeling. In this step, a code block is decomposed into so-called magnitude bit planes, which are arranged, or produced, in the sequence starting with the MSBs, or most significant bits, to the LSBs, or least significant bits, and associated sign bits, which are handled, or contemplated, separately. Each magnitude bit plane is modeled in a succession of three coding passes, except for the first bit plane, which is modeled with only one coding pass. Said coding passes traverse the bits of a magnitude bit plane in a specific sequence. The bit at the top left position is the one started with, then come three bits positioned underneath, before a jump is made to the right by one column. This results in a so-called stripe having the width of the code block and the height of four coefficients. Once a code block has been processed in the horizontal direction, the next stripe is processed four coefficient positions down, etc.

ISO/IEC15444-1 describes in more detail whether a coding scheme, and, if so, which coding scheme, is applied during a coding pass. In particular, this decision is made coefficient by coefficient. In other words, only specific coefficients are modeled in the first coding pass. The second coding pass also codes some of the remaining coefficients. The remainder is modeled by the third coding pass. Which coefficient belongs to which coding pass depends, among other things, on whether the respective coefficient is significant, or depends on the significance of its direct neighbors. ISO/IEC15444-1, referred to as the standard below for short, defines a binary status variable for each coefficient within a code block, the so-called “significance status”. Said status variable, which is initialized to being “insignificant” at the beginning, changes to “significant” at that magnitude bit plane where a set bit of the coefficient is to be modeled for the first time, and it will thus remain set until the end of the modeling of said code block.

A data bit is generated along with one context index, in each case, for a bit of a coefficient which is modeled by a coding scheme during a coding pass within a specific bit plane. Said context index primarily results from the significance status variables of the coefficient and its neighbors. For specific coding passes, namely the first and third ones, it so happens that the sign bit of the current coefficient, too, is to be modeled along with a context index, which context index again depends on the significance status variables and the signs of its neighbors. A so-called “magnitude refinement”, or MR, coding scheme, or the second coding pass, initially evaluates whether this scheme was already applied to the coefficient to be modeled within previous bit planes, or whether it is being applied for the first time. The arithmetic coder connected downstream expects the bit context pairs in the sequence which was set in the manner described above.

If one follows the sequence in which the bit context pairs are to be coded by the arithmetic coder in accordance with the standard, this results in a sequential succession with regard to the coding passes, as was described above and as is complied with, in particular, by software implementations. By implementations in hardware, a higher coding speed may be achieved. For example, several code blocks may be coded simultaneously independently of one another in that several block coders are instantiated in parallel. However, this constitutes a massive consumption of resources, for example with regard to the transistors that may be used on an integrated circuit or with regard to the gate equivalents in an FPGA (field programmable gate array).

In Lian et al.: Analysis and Architecture Design of Block-Coding Engine for EBCOT in JPEG 2000, IEEE Transactions on Circuits and Systems for Video Technology, Vol. 13, No. 3, March 2003, pp. 219-230, a description is given, for example, of a hardware design of the block coder in JPEG2000, wherein savings are achieved, during each pass, in terms of verifications that may be made per coefficient as to whether the respective coefficient belongs to the respective pass, in that the membership verifications are parallelized, and in that columns of 4 or groups of columns of 4 per pass are skipped, depending on whether no or one or several bits belong to the respective pass. A hardware solution for the JPEG2000 block coder suggested in Gangadhar and Bhatia: FPGA based EBCOT Architecture for FPEG2000, Field-Programmable Technology (FPT), 2003, Proceedings 2003, IEE International Conference, pp. 228 to 233, goes one step further and suggests parallelizing the passes, so that fewer clock cycles may be used for coding the code blocks. In addition to a memory for storing the magnitude bits and sign bits, a buffer for temporarily storing updated significance status variables is provided between a processing unit, which takes care of the first coding pass, and a second processing unit, which is responsible for the coding passes 2 and 3.

However, it remains desirable to find a solution, which may be effectively configured in hardware, for coding transformation coefficient blocks, as it occurs, for example, in JPEG2000 coding.

### SUMMARY OF THE INVENTION

According to an embodiment, a device for coding a block of transformation coefficients, the transformation coefficients each being represented by means of several magnitude bits, so that same define a sequence of magnitude bit planes, may have: a precoder for traversing the magnitude bits of a predetermined one of the magnitude bit planes in tuples of a plurality of adjacent magnitude bits in each case, and for coding predetermined ones of the magnitude bits of the tuples into data words such that a predetermined magnitude bit is coded, along with an associated sign bit, into one of the data words, or that a predetermined magnitude bit is coded, along with any other predetermined magnitude bit of the same tuple, into one of the data words, and coding other magnitude bits of the tuples, which are different from the predetermined magnitude bits, into further data words such that one of the other magnitude bits is coded into one of the further data words along with an associated sign bit, or that one of the other magnitude bits is coded into one of the further data words along with another one of the other magnitude bits of the same tuple; a data word buffer for temporarily storing the data words; a further data word buffer for temporarily storing the further data words; and an entropy coder for coding the data words and the further data words from the data word buffer and the further data word buffer into a coded data stream, specifically by coding at first the data words in the buffer and then the further data words in the further buffer.

According to another embodiment, a device for coding a block of transformation coefficients, the transformation coefficients each being represented by means of several magnitude bits so that same define a sequence of magnitude bit planes, may have: a coder for traversing the magnitude bits of a predetermined one of the magnitude bit planes, and for coding predetermined ones of the magnitude bits into a coded data stream, the coder including: a buffer; a bit extractor for determining, while traversing the magnitude bits, first status bits which indicate a significance, in relation to the predetermined magnitude bit plane, for the transformation coefficients which are represented by magnitude bits of the predetermined magnitude bit plane which are, at the earliest, to be processed next according to a pass sequence, from magnitude bits which represent the same transformation coefficients as the magnitude bits which, at the earliest, are to be processed next, but are located within more significant bit planes than the former, and for filling the buffer with the first status bits determined; and a coder for coding the predetermined magnitude bits into the coded data stream while using the first status bits in the buffer, wherein the buffer is configured such that at any time, it stores the first status bits for only a section of the transformation coefficients, and wherein the coder is configured to traverse a less significant magnitude bit plane upon traversing the predetermined magnitude bit plane, and to code the predetermined magnitude bits of the less significant magnitude bit plane into the data stream, specifically while determining the first status bits and while filling the buffer by the bit extractor.

According to another embodiment, a device for coding a block of transformation coefficients, the transformation coefficients each being represented by means of several magnitude bits, so that same define a sequence of magnitude bit planes, may have: a coder for traversing the magnitude bits of a predetermined one of the magnitude bit planes in tuples of a plurality of adjacent magnitude bits of the predetermined magnitude bit plane in each case, and for coding the magnitude bits of the tuples into a coded data stream, the magnitude bits belonging to first, second and third passes, respectively; and a predictor for predicting whether, and, if so, which of the magnitude bit(s) among the adjacent magnitude bits of the predetermined magnitude bit plane of a tuple that is, at the earliest, to be processed next according to a pass sequence, belong(s) to which of said first, second and third passes, said coding unit including a precoder for each of the passes, said precoders being configured to code, during traversal, those magnitude bits from the tuple currently being processed which belong to the respective pass; for each of the precoders, a buffer for temporarily storing the data words of the respective precoder; and an entropy coder configured to code the data words in the buffers in the order of the passes, each precoder being configured to serially code a selection of the magnitude bits of the tuple currently being processed into the coded data stream and to adjust the selection on the basis of the prediction, or being configured to code the magnitude bits of the tuple currently being processed into partial data words by means of parallel processing, said partial data words forming a data word of the respective precoder and including an admissible state or an inadmissible state, depending on the prediction, so that it may be determined exclusively by means of the data word which of the partial data words have been produced for magnitude bits which belong to the magnitude bits of the respective pass.

According to another embodiment, a method of coding a block of transformation coefficients, the transformation coefficients each being represented by means of several magnitude bits, so that same define a sequence of magnitude bit planes, may have the steps of traversing the magnitude bits of a predetermined one of the magnitude bit planes in tuples of a plurality of adjacent magnitude bits in each case, and for coding predetermined ones of the magnitude bits of the tuples into data words such that a predetermined magnitude bit is coded, along with an associated sign bit, into one of the data words, or that a predetermined magnitude bit is coded, along with any other predetermined magnitude bit of the same tuple, into one of the data words, and coding other magnitude bits of the tuples, which are different from the predetermined magnitude bits, into further data words such that one of the other magnitude bits is coded into one of the further data words along with an associated sign bit, or that one of the other magnitude bits is coded into one of the further data words along with another one of the other magnitude bits of the same tuple; temporarily storing the data words in a data word buffer; temporarily storing the further data words in a further data word buffer; and coding the temporarily stored data words and the further data words from the data word buffer and the further data word buffer into a coded data stream, specifically by coding at first the data words in the buffer and then the further data words in the further buffer.

According to another embodiment, a method of coding a block of transformation coefficients, the transformation coefficients each being represented by means of several magnitude bits so that same define a sequence of magnitude bit planes, may have the steps of: traversing the magnitude bits of a predetermined one of the magnitude bit planes, and for coding predetermined ones of the magnitude bits into a coded data stream while performing the following: determining, while traversing the magnitude bits, first status bits which indicate a significance, in relation to the predetermined magnitude bit plane, for the transformation coefficients which are represented by magnitude bits of the predetermined magnitude bit plane which are, at the earliest, to be processed next according to a pass sequence, from magnitude bits which represent the same transformation coefficients as the magnitude bits which, at the earliest, are to be processed next, but are located within more significant bit planes than the former; filling a buffer with the first status bits determined; and coding the predetermined magnitude bits into the coded data stream while using the first status bits in the buffer, wherein the buffer is configured such that at any time, it stores the first status bits for only a section of the transformation coefficients, and wherein upon traversal of the predetermined magnitude bit plane, a less significant magnitude bit plane is traversed, specifically while coding the predetermined magnitude bits of the less significant magnitude bit plane into the data stream, while re-determining the first status bits, and while refilling the buffer.

According to another embodiment, a method of coding a block of transformation coefficients, the transformation coefficients each being represented by means of several magnitude bits, so that same define a sequence of magnitude bit planes, may have the steps of: traversing the magnitude bits of a predetermined one of the magnitude bit planes in tuples of a plurality of adjacent magnitude bits of the predetermined magnitude bit plane in each case while coding the magnitude bits of the tuples into a coded data stream, the magnitude bits each belonging to one of a first, second and third pass, a precoding for each of the passes being used for coding, said precoding taking place so as to code, during traversal, the magnitude bits from the tuple currently being processed which belong to the respective pass into data words; predicting whether, and, if so, which of the magnitude bit(s) among the adjacent magnitude bits of the predetermined magnitude bit plane of a tuple which, at the earliest, is to be processed next according to a pass sequence belong(s) to which pass; temporarily storing the data words of the respective precoder in a respective buffer; and entropy coding the data words in the buffers in the sequence of the passes, wherein for each pass within the context of the respective precoding, a selection of the magnitude bits of the tuple currently being processed is serially coded into the coded data stream, and the selection is adjusted on the basis of the prediction, or within the context of the respective precoding, the magnitude bits of the tuple currently being processed are coded, by means of parallel processing, into partial data words which form a data word of the respective precoder and include an admissible state or an inadmissible state, depending on the prediction, so that it may be determined exclusively by means of the data word which of the partial data words have been produced for magnitude bits which belong to the magnitude bits of the respective pass.

According to another embodiment, a program may have a program code for performing the method of coding a block of transformation coefficients, the transformation coefficients each being represented by means of several magnitude bits, so that same define a sequence of magnitude bit planes, wherein the method may have the steps of traversing the magnitude bits of a predetermined one of the magnitude bit planes in tuples of a plurality of adjacent magnitude bits in each case, and for coding predetermined ones of the magnitude bits of the tuples into data words such that a predetermined magnitude bit is coded, along with an associated sign bit, into one of the data words, or that a predetermined magnitude bit is coded, along with any other predetermined magnitude bit of the same tuple, into one of the data words, and coding other magnitude bits of the tuples, which are different from the predetermined magnitude bits, into further data words such that one of the other magnitude bits is coded into one of the further data words along with an associated sign bit, or that one of the other magnitude bits is coded into one of the further data words along with another one of the other magnitude bits of the same tuple; temporarily storing the data words in a data word buffer; temporarily storing the further data words in a further data word buffer; and coding the temporarily stored data words and the further data words from the data word buffer and the further data word buffer into a coded data stream, specifically by coding at first the data words in the buffer and then the further data words in the further buffer, when the program runs on a processor.

In accordance with a first aspect, a device for coding a block of transformation coefficients, the transformation coefficients each being represented by means of several magnitude bits, so that same define a sequence of magnitude bit planes, comprises a precoder for traversing the magnitude bits of a predetermined one of the magnitude bit planes in tuples of a plurality of adjacent magnitude bits in each case, and for coding predetermined ones of the magnitude bits of the tuples into data words such that a predetermined magnitude bit is coded, along with an associated sign bit, into one of the data words, or that a predetermined magnitude bit is coded, along with any other predetermined magnitude bit of the same tuple, into one of the data words, a data word buffer for temporarily storing the data words, and an entropy coder for coding the data words from the data word buffer into a coded data stream.

A core idea of the first aspect is that faster completion or coding may be achieved by utilizing a precoder, which—when traversing the magnitude bits of a predetermined magnitude bit plane in tuples of a plurality of adjacent magnitude bits, respectively—codes predetermined ones of the magnitude bits of the tuples into a data word, but in each case along with a sign bit, or as a group of several of them, and by utilizing a buffer for the data words which is connected between the precoder, on the one side, and an entropy coder, on the other side. The independence of the coder operation of the entropy coder operation also enables the entropy coder to code, for example, data words of other precoders, which are responsible for other predetermined magnitude bits, while the precoder already traverses a next magnitude bit plane.

In accordance with an embodiment, the precoder also codes, along with a predetermined magnitude bit, an associated sign bit into a data word, so that the data word comprises, for example, a partial data word for the magnitude bit, and a partial data word for the associated sign bit. Thus, both processes may be precoded in parallel within a clock cycle. The entropy coder may reconstruct and entropy-code the magnitude bit from the data word within the buffer, and subsequently it may or may not perform entropy-coding of the sign bit, depending on the significance of the magnitude bit that has just been coded.

In accordance with a further embodiment, the precoder performs the coding—while traversing the predetermined magnitude bits—such that at least two predetermined magnitude bits within a tuple are coded into a data word. For this purpose, the precoder comprises, for example for each magnitude within a tuple, a precoding unit for coding the respective magnitude bit into a partial data word, which together are included within a data word for the tuple, so that, again, any processing operations may be performed in parallel. In addition, provision may be made for the partial data words from which the respective magnitude bit and the associated context for entropy coding may be taken to have a dedicated state which indicates that the respective magnitude bit of the respective tuple does not belong to the predetermined magnitude bit, so that the entropy coder may distinguish such magnitude bits which are to be coded into the data stream from such ones which are not to be coded into the data stream.

In accordance with a second aspect, a device for coding a block of transformation coefficients, the transformation coefficients each being represented by means of several magnitude bits so that same define a sequence of magnitude bit planes, comprises a coding means for traversing the magnitude bits of a predetermined one of the magnitude bit planes, and for coding predetermined ones of the magnitude bits of the tuples into a coded data stream, the coding means comprising a buffer 106; a bit extractor 104 for determining, while traversing the magnitude bits, first status bits which indicate a significance, in relation to the predetermined magnitude bit plane, for the transformation coefficients which are represented by magnitude bits of the predetermined magnitude bit plane which are, at the earliest, to be processed next according to a pass sequence, from magnitude bits which represent the same transformation coefficients as the magnitude bits which, at the earliest, are to be processed next, but are located within more significant bit planes than the former, and for filling the buffer with the first status bits determined; and a coder for coding the predetermined magnitude bits into the coded data stream while using the first status bits in the buffer.

One finding of the second aspect is that a more effective or more efficient implementation of the transformation coefficient block coder is made, possible when a coder codes the predetermined magnitude bits into the coded data stream while utilizing status bits in a buffer, which is filled, by a bit extractor, on the basis of information which comprises magnitude bits which represent the same transformation coefficients as the magnitude bits which, at the earliest, are to be processed next, but are located within more significant bit planes than the former.

In this manner it is possible to store the significance information—which may possibly be used by the coding means in order to decide whether and, if so, which of the magnitude bit(s) of the predetermined magnitude bit plane belong(s) to the predetermined magnitude bits—only temporarily and/or locally, while the magnitude bits are being traversed, in the vicinity of the magnitude bit currently being processed, which results in a relatively large memory for storing the significance information being dispensed with. In turn, this results in that the memory requirement may be kept small, so that, conversely, a more complicated, but, conversely, faster memory technology may be used for storing these status bits. Even though the status information is only temporarily stored in the buffer, the content with which the buffer is filled may be updated so as to use said updated content during the coding process. The additional expense for the logic for constantly extracting the status information instead of storage and restoration across all bit planes is relatively small as compared to the savings achieved in terms of memory expenditure. Also, the extraction does not constitute any lost time, since the extraction may be performed in parallel with the actual coding process.

In accordance with a third aspect, an inventive device for coding a block of transformation coefficients, the transformation coefficients each being represented by means of several magnitude bits, so that same define a sequence of magnitude bit planes, comprises a coding means for traversing the magnitude bits of a predetermined one of the magnitude bit planes in tuples of a plurality of adjacent magnitude bits in each case, and for coding predetermined ones of the magnitude bits of the tuples into a coded data stream, and a prediction means for predicting whether, and, if so, which of the magnitude bit(s) among the adjacent magnitude bits of the predetermined magnitude bit plane of a tuple that is, at the earliest, to be processed next according to a pass sequence, belong(s) to the predetermined magnitude bits, said coding unit being configured to perform the coding in dependence on the prediction.

A core idea of the third aspect is that a more effective or more efficient implementation of transformation coefficient block coding may be achieved, for example in hardware, when a prediction means is provided which predicts whether, and if so, which of the magnitude bit(s) among the adjacent magnitude bits of the predetermined magnitude bit plane of a tuple that is, at the earliest, to be processed next according to a pass sequence, belong(s) to the predetermined magnitude bit.

In accordance with an embodiment, the prediction is based on magnitude bits of the current magnitude bit plane in tuples which, according to the pass sequence, follow the tuple that was the most recent one to be processed. For example, these magnitude bits may be used for modifying or updating such significance information which indicates, for the magnitude bits of the tuples which follow the tuple that was the most recent one to be processed, the significance of the transformation coefficients, represented by same, with regard to the current magnitude bit plane. Thereby it is possible to complete a sequential execution, which may be used in virtual terms, of passes of the magnitude bits of the current magnitude bit plane in tuples for different ones of the magnitude bits of the current magnitude bit plane within a pass while taking into account that, in accordance with the virtual sequence, any passes which are to be processed later on would have other significances if the virtual sequence had been kept to. A prediction which depends on said significance information thus is also enabled if completion of the virtual sequence of passes is executed in one go.

However, this does not only apply to the case of parallel completion of any passes which are to be performed in a virtually sequential manner. If among the magnitude bits of the tuples, too, a virtual sequence of passes is specified in which the pass is to take place virtually, and/or if the membership of a specific magnitude bit also depends on the significance of its neighbors, utilization of the magnitude bits of the current magnitude bit plane in tuples which follow, according to the pass sequence, that tuple which was the most recent one to be processed, will allow taking into account that if the respective virtual inter- and/or inner-tuple sequences had been kept to, a different membership would be true for any magnitude bits which, in accordance with the virtual inter-tuple sequence and/or inner-tuple sequence, are to be processed later on.

Generally, the prediction enables that the coding means may immediately start processing the predetermined magnitude bit(s) in the current tuple, or that the coding means may use only processing cycles for processing magnitude bits in the tuples which also belong to the predetermined magnitude bits. Thus, the coding means may be configured to sequentially code the predetermined magnitude bits in the respective tuples, and for this purpose it may use only the smallest number of processing cycles possible. However, it is also possible for the coding means to be suited for processing all of the magnitude bits in a tuple in parallel, but to be able, as a result of the prediction, to take into account, within one and the same processing cycle, not only the magnitude bit values per se, but also whether or not the respective magnitude bit belongs to the predetermined magnitude bit, so as to, in the latter case, convert—within the same processing cycle—the respective magnitude bit to a pair of data value and associated coding context, said pair exhibiting a state which does not come up for any magnitude bits which do not belong to the predetermined magnitude bits, such as by adjusting an inadmissible coding context.

Consequently, the prediction means enables fast implementation of coding which may use fewer processing cycles.

### BRIEF DESCRIPTION OF THE DRAWINGS

Further embodiments of the present invention will be explained in more detail below with reference to the figures, wherein:

FIG. 1 shows a block diagram of an image compressor, wherein the inventive transformation coefficient block coding may be applied;

FIG. 2 shows a schematic representation of a subdivision of the transformation coefficients into magnitude bits and sign bits;

FIG. 3 shows a block diagram of a block coder in accordance with an embodiment of the present invention;

FIG. 4 shows a block diagram of the bit modeling unit of coding pass 1 of FIG. 3 in accordance with an embodiment of the present invention;

FIG. 5 shows a block diagram of the bit modeling unit for coding pass 2 of FIG. 3 in accordance with an embodiment of the present invention;

FIG. 6 shows a block diagram of the bit modeling unit for coding pass 3 of FIG. 3 in accordance with an embodiment of the present invention;

FIG. 7 shows a block diagram of the pass decider of FIG. 3 in accordance with an embodiment of the present invention;

FIG. 8 shows a schematic representation for illustrating the size of the shift register unit of FIG. 3 and of the content stored therein at a respective point in time;

FIG. 9 shows a block diagram of a block coder in accordance with a further embodiment of the present invention;

FIG. 10 shows a block diagram of a block coder in accordance with a further embodiment of the present invention; and

FIG. 11 shows a block diagram of a block coder in accordance with a further embodiment of the present invention.

### DETAILED DESCRIPTION OF THE INVENTION

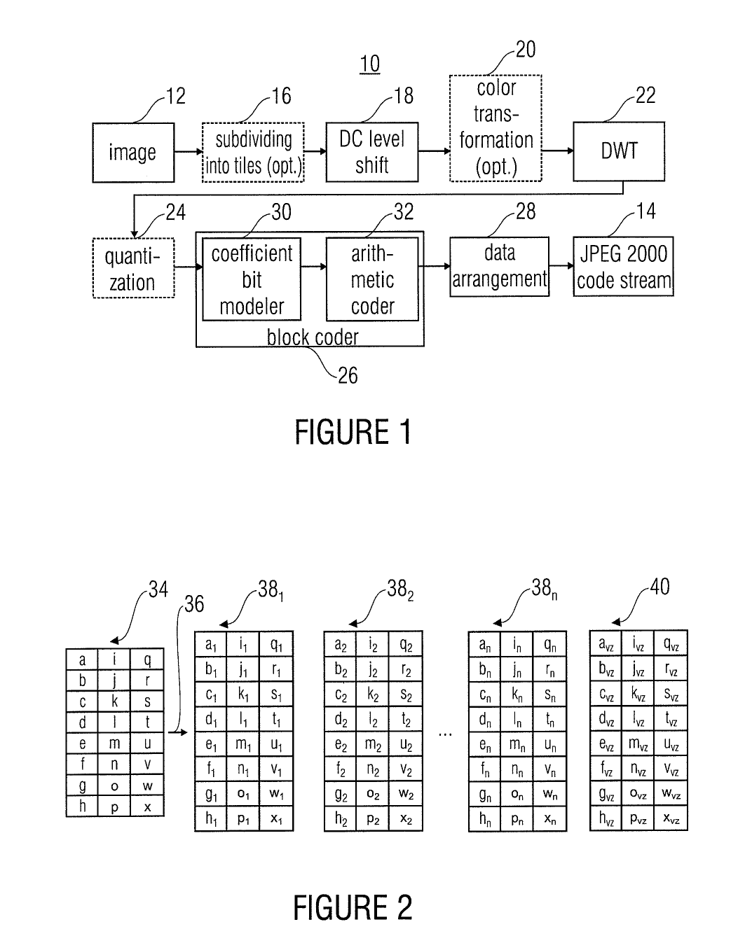

FIG. 1 shows an image compressor 10 as an example of a case of application wherein the embodiments described below may be advantageously used. The image compressor 10 of FIG. 1 is configured to compress a source image 12 consisting of samples or pixel values arranged, e.g., in columns and rows, into a coded data stream, or code stream 14. For this purpose, the compressor 10 of FIG. 1 comprises, for example, a series connection of, optionally, a tile subdivider 16, a DC portion level shifter 18, optionally, a color transformer 20, a transformer 22 for spatial spectral decomposition, an optional quantizer 24, a block coder 26 and a data arranger 28. The tile subdivider subdivides the image 12 into, e.g., rectangular image areas, so-called tiles. Further processing is performed per tile, so that further compression in the individual tiles takes place independently. The DC signal level shifter 18 performs, within each tile, a DC signal shift which is uniform across all of the pixels of the respective tile, so that, for example, the average of the pixel values, such as of the luminance values, will subsequently amount to zero. The color transformer 20 optionally subjects the pixel values to a color transformation, the color transformation being optional and naturally only taking place in the case of color images 12. Subsequently, the transformer 22 performs a spatial spectral decomposition per tile. In the case of a JPEG2000 code stream 14 to be generated, the transformation is a wavelet transformation, for example, more specifically a discrete wavelet transformation, which is applied to each tile individually. In this manner, each tile is decomposed into different dissolution levels or decomposition levels which consist of subbands of transformation coefficients describing frequency characteristics of local areas of each tile. The transformation coefficients may already be integers. Optionally, the quantizer 24 subjects the transformation coefficients to scalar quantization and combines same into code blocks, i.e. into, e.g., square arrays of transformation coefficients. The block coder 26 entropy-codes the transformation coefficients within the code blocks into data streams bit plane by bit plane, whereupon the data arranger 28 suitably arranges the arithmetically coded code block data streams so as to form the code stream 14, such as a code stream which conforms with JPEG2000.

In particular, as is shown in FIG. 1, the block coder 26 comprises a coefficient bit modeler 30 having an arithmetic coder 31 connected downstream from it. The coefficient bit modeler 30 associates contexts, which are used by the arithmetic coder 32 for arithmetic coding, with the magnitude bits of the coefficients. In particular, the arithmetic coder 32 is a binary arithmetic coder operating in dependence on the context and being configured to subdivide a current interval, which represents the instantaneous state of the arithmetic coder, into two halves in dependence on estimation probabilities in terms of the occurrence of a respective bit value for the next bit to be coded, and to select, among said halves, one half so as to limit the current interval to this interval, depending on the actual bit value of the current bit to be coded, said estimation probabilities being different for each context, and the context being determined by the coefficient bit modeler 30 in dependence on adjacent significances and/or magnitude bit values and a plurality of possible contexts. In addition, the coder may operate adaptively so as to adapt the pre-initialized estimation probabilities to the actual probabilities per context during the coding process.

The following explanation of embodiments of the present invention will initially focus on a compression which conforms to JPEG2000, which is why the task of the block coder 26 is to be illustrated in more detail below against this background. In particular, the individual magnitude bits of the transformation coefficients within a block are to be coded, by the block coder 26, into the arithmetically coded data stream of the arithmetic coder 32 on a predetermined, or predefined, sequence, namely, in particular, initially bit plane by bit plane, from the most significant bit plane to the least significant bit plane, and, within said bit planes, by scanning the coefficient magnitude bits in three passes in a predefined scan sequence, only such magnitude bits being coded in each pass which meet specific criteria, such that, with said three passes, all of the magnitude bits may be reconstructed from the arithmetically coded data stream. To illustrate the subdivision into bit planes, and the scan sequence within said planes, FIG. 2 shows a code block of the size 3×8, by way of example.

In particular, at 34 FIG. 2 shows, by way of example, a 3×8 code block having 3×8 transformation coefficients a to x. As is indicated by the arrow 36, each coefficient a to x is represented by n magnitude bits a₁ . . . n, x₁ . . . xₙ and by a respective sign bit a_{vz}, . . . , x_{vz}, the splitting 36 into magnitude bits and sign bits inherently resulting from the kind of discrete wavelet transformation 22 or from the quantization 24 (FIG. 1). The MSBs, or most significant magnitude bits, are the bits a₁ . . . x₁, for example, and form a first magnitude bit plane 38₁. Likewise, the other magnitude bits may be combined into respective bit planes 38₂ . . . 38ₙ. Each bit plane 38₁ . . . 38ₙ as well as the sign bits 40 thus form a 3×8 bit array, respectively.

The scan sequence mentioned above provides that the bits of a bit plane 38₁ . . . 38ₙ are scanned, in columns of four or in tuples of four magnitude bits mutually adjacent in the column direction in each case, from one row end to the other, i.e. stripe by stripe, whereupon the next stripe in the next rows is scanned, and the magnitude bits are scanned from top to bottom within each vector of four columns, or within each tuple. Consequently, for the bit planes 38₁ . . . 38ₙ, the scan pattern may be represented as

aᵢ, bᵢ, cᵢ, dᵢ, iᵢ, jᵢ, kᵢ, lᵢ, qᵢ, rᵢ, sᵢ, tᵢ, eᵢ, fᵢ, gᵢ, hᵢ, mᵢ, nᵢ, oᵢ, pᵢ, uᵢ, vᵢ, wᵢ, xᵢ, with i=1 . . . n,
said scan pattern here comprising six columns of four, or tuples, and two stripes, by way of example.

Triple scanning of the magnitude bits of the individual bit planes is avoided, in accordance with the embodiment described below of a block coder 26, in that the magnitude bits associated with the respective passes are recognized by means of a scan, and are coded into data words from which the bit values and the associated contexts result, whereupon they are coded into an arithmetically coded data stream in a suitable sequence after having been temporarily stored in a buffer. In this context, constant looking up in a memory is avoided in that the magnitude bits and sign bits are temporarily stored.

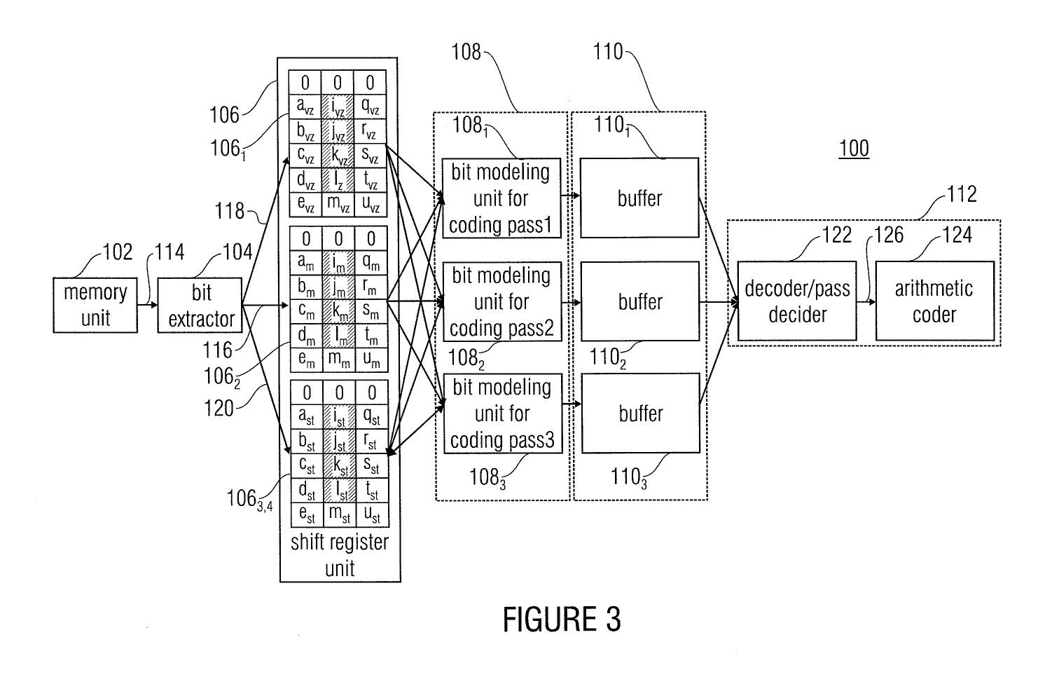

FIG. 3 shows a block coder 100 in accordance with an embodiment of the present invention. It comprises a memory unit 102, a bit extractor 104, a shift register unit 106, a coefficient bit modeler stage 108, a buffer 110, and an arithmetic coding means 112. The memory unit 102 is a random access memory, for example, such as a RAM, and acts as an interface for obtaining the quantized signed transformation coefficients of the code blocks to be coded, e.g. of the code block 34 of FIG. 2. The bit extractor 104 is coupled to the memory 102 so as to perform accesses 114 to the memory content of the memory unit 102 so as to read magnitude bits and sign bits from the memory unit 102. What follows is a more detailed description of when the bit extractor 104 accesses which magnitude bits and/or sign bits. At any rate, the bit extractor 104 is responsible for filling the shift register unit 106, on the basis of the information read out from the memory unit 102, with bits which may be used by the coefficient bit modeling stage 108 for performing the appropriate context generation operations, or the appropriate precoding. Put somewhat more concretely, the bit extractor 104 scans, in a manner presented in somewhat more detail below, the magnitude bits of the current magnitude bit plane, magnitude bit plane by magnitude bit plane, along the specified stripes, and permanently fills the shift register unit 106 with information during the scanning, so that, due to its shift register length, the shift register unit 106 comprises information bits with regard to a current section of the current magnitude bit plane along the stripes which may currently be used by the coefficient bit modeling stage 108 for its context generation or precoding. In anticipation of the more detailed description presented later on, the bit extractor 104 forms, by mere takeover, the magnitude bits 108 of the current bit plane which are to be newly accepted, for example from the coefficient magnitude bits and the sign bits, forms, by mere takeover, the sign bits 118 to be newly accepted, and forms, by suitably combining, associated status bits 120, and feeds same to the shift register unit 106 which is dimensioned such that it may hold the individual bits 108, 110, 112 in a depth of a respective suitable number of shift stages or ranks; as will be described in more detail below. Any adjacent bits located at the edge of the code block are filled up with zeros accordingly, as is presented, by way of example, in FIG. 3 for the upper adjacent bits.

FIG. 3 shows, in a simplified manner, that the shift register 106 would provide four registers (shown to be hatched) along with 14 adjacent registers, respectively, specifically for the coefficient bits 108, sign bits 118 and status bits 120, respectively. Thus, the shift register unit 106 may be considered to comprise several shift registers 106_{1,2,3,4}, one each for the magnitude bits, sign bits and two different status bits, which will be described in more detail below, said individual shift registers 106_{1 . . . 4} being synchronized with one another, so that all of the register contents are advanced at the same time, per shift pulse, by one position in the horizontal direction, or by one shift register rank, i.e. by a vector of 6 in FIG. 3.

Internally, the coefficient bit modeling stage 108 is subdivided into several bit modeling units 108₁, 108₂ and 108₃, the first of which being responsible for pass 1, the second for pass 2, and the third for pass 3, and which will be described below in more detail. The individual units 108₁-108₃ are each coupled to respective bit registers of the shift registers 106₁-106₄ so as to analyze the respective register contents and to establish, for each bit to be modeled among a current tuple of magnitude bits which responds to the registers which are hatched in FIG. 3, whether or not it is to be modeled in accordance with the respective pass, and, if this is so, with which result. The bit modeling units 108₁-108₃ are configured, in particular, to generate, per tuple or per magnitude bit belonging to the respective pass, a data word which is precoded accordingly, inclusive of control bits which will be explained in more detail below, and to store it in the respective buffers 110₁, 110₂ and 110₃ of the buffer stage 110. Data words which belong to tuples containing no magnitude bit which belongs to the respective pass may be discarded, as will be described below, just like data words for magnitude bits which do not belong to the respective pass.

In particular, the bit modeling units 108₁-108₃ may be configured to adjust, within the data words, control bits which may be used by the subsequent arithmetic coding means 112 for inserting the data words which are stored into the buffers 110₁-110₃, or the magnitude bits coded within same, into the data stream in the suitable sequence and while using the right context or while interrupting the arithmetic coding in a different mode, such as a clear-text mode, as will be explained in more detail below. For this purpose, the arithmetic coding means 112 comprises, in particular, a pass decider 122 which has an arithmetic coder 124 connected downstream from it. The pass decider 122 acts as a coder of the precoded data words in the buffers 110₁-110₃, and to this end is coupled to the latter. From said data words, the pass decider 122 reconstructs the bits, which are modeled according to context in passes 1, 2 and 3, with the associated context, and forwards these pairs to the arithmetic coder 124 in the suitable sequence, i.e. pass 1 followed by pass 2 followed by pass three, it being possible for the forwarded information to also contain, in addition to the bit values and the associated context indices, information on coding modes to be used by the arithmetic coder 124, or the like, the control signals from the decider 122 to the arithmetic coder 124 generally being designated by 126 in FIG. 3. In other words, the pass decider 122 codes the read-out data words in the buffers 110 back into bit/context pairs 126, and supplies same to the downstream arithmetic coder 124 in a specified manner and in a suitable representation.

Above, a rough description was given of the architecture of the block coder 100 of FIG. 3, and the tasks and functionalities of the individual units were outlined. Before a detailed description of the bit modeling units 108₁-108₃ and of the pass decider 122, and, based thereon, a detailed description of the mode of operation of the block coder 100 is given, the general goal of the interaction of the units of FIG. 3 shall once again be outlined briefly so as to thereby provide an overview which may be useful for understanding the following detailed description. As was already mentioned, the bit extractor 104 takes care of filling the shift register unit 106. In this context, the bit extractor 104 scans the current magnitude bit plane stripe by stripe. In a first approximation one may therefore think of the shift register unit 106 as a window moving across the current magnitude bit plane along the scan sequence, with a synchronous movement of a corresponding window in the sign bit plane 40 (FIG. 2) and while temporarily storing associated status bits for said window contents. For their work, the bit modeling units 108₁-108₃ may use no further information than that contained within the shift register unit 106, which is why tedious memory accesses 114 to the memory unit 102 are not necessary. In addition, only one pass through the current magnitude bit plane may be used, even though, as was already discussed above, three passes are specified by the standard for defining the sequence in which the magnitude bits are to be coded into the data stream. To achieve the latter, each of the bit modeling units 108₁-108₃ only takes care of those magnitude bits in the tuples of four which belong to the respective pass of their own. Generally, one may state that pass 1 takes care of magnitude bits of transformation coefficients which are not yet significant, i.e. whose magnitude bits in the more significant magnitude bit planes are zero, or non-significant, but which are adjacent to transformation coefficients which are significant. To eliminate confusion, it shall be noted that a transformation coefficient within a specific magnitude bit plane is referred to as significant if at least one of the magnitude bits within the more significant magnitude bit planes is 1, and that same “becomes significant” within a specific magnitude bit plane if none of the magnitude bits within the more significant magnitude bit planes is 1, but becomes significant during the coding of the current bit plane—still within said plane—by a magnitude bit of 1. A magnitude bit is referred to as significant if it is 1. Pass 2 takes care of transformation coefficients which are already significant within the current magnitude bit plane. Finally, pass 3 addresses the remaining magnitude bits, i.e. the magnitude bits of transformation coefficients which are non-significant and did not come under pass 1.

The significances of the transformation coefficients within the magnitude bit plane currently to be coded play an important role in the model or context formation performed by the bit modeling units 108₁-108₃, since the contexts are determined on the basis thereof, and since this information is already present at the decoder during decoding, and since said decoder may therefore reproduce context modeling. It should be noted at this point already that the decision as to whether a specific magnitude bit belongs to pass 3 is dependent, among other things, on whether one of the adjacent magnitude bits actually does belong to a non-significant transformation coefficient in a logical sequence prior to pass 1, but belongs to pass 1 and therefore becomes significant even before the end of pass 1—possibly in a virtual manner, or in accordance with the sequence specified in the standard, according to which the passes are performed one after the other—in which case the respective magnitude bit might actually not belong to pass 3 but to pass 1. However, the problem of adjacent magnitude bits becoming significant naturally only relates to those adjacent magnitude bits which, in accordance with the magnitude bit scan sequence, are positioned before the magnitude bit currently contemplated.

The bit modeling units 108₁-108₃ fill up their respective buffers 110₁-110₃ with successive data words which are read out by the pass decider 122 one after the other, specifically in a magnitude bit plane by magnitude bit plane manner, i.e. starting with the buffer 110₁ and continuing for such time until the last data word of the current magnitude bit plane has been read out, then proceeding with the buffer 110₂ for such time until the last data word has been read out from the current magnitude bit plane, again followed by the buffer 110₃ for such time until the last data word has been read out, a start being made, by way of exception, directly with the buffer 110₃ within the first, or most significant, magnitude bit plane since, within said magnitude bit plane, no transformation coefficient is significant yet, and since, therefore, no magnitude bit of this plane may belong to any other pass than pass 3. In the pass decider 122, the data words are also decoded and converted to respective control signals for the arithmetic coder 124, which forms a coded data stream for the code block from same.

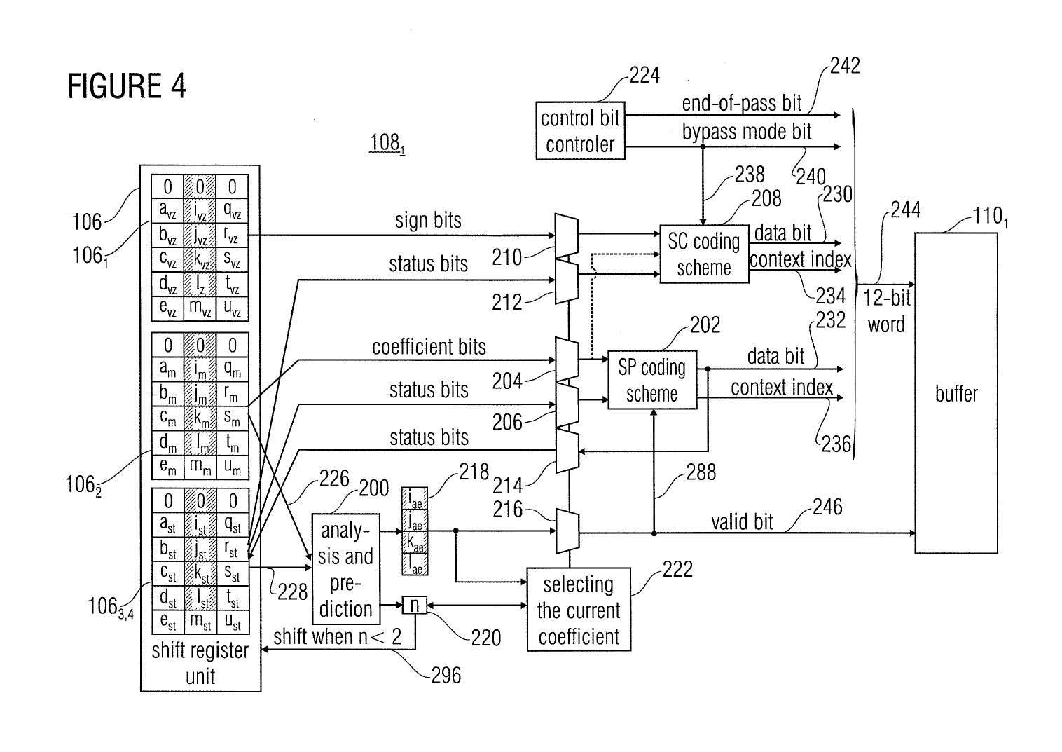

The internal architecture of the bit modeling units and of the pass decider of FIG. 3 shall be described below in more detail. FIG. 4 shows the architecture of the bit modeling unit 108₁. It is responsible for pass 1, i.e. for the first coding pass, which is also referred to as a “significance propagation pass” since it relates to magnitude bits of transformation coefficients which are located in the vicinity of transformation coefficients which are already significant, and which are therefore more likely to become significant than the transformation coefficients which are still located at a larger distance from already significant ones. As was mentioned above, the decision as to whether a respective magnitude bit is to be modeled in the coding pass 1 is based on whether the respective coefficient is still insignificant to the current bit plane and whether at least one of its direct adjacent coefficients is significant or becomes significant during the course of the first pass.

The bit modeling unit 108₁ comprises an analysis prediction unit 200, a magnitude bit precoding unit 202, multiplexers 204, 206 which are connected upstream from the latter on the input side, a sign bit precoding unit 208, multiplexers 210, 212 which are connected upstream from the latter on the input side, an updating demultiplexer 214, a validity bit multiplexer 216, a four-bit register 218, a clock counter 220, a coefficient selector 222, and a control bit controller 224, the buffer 110₁ as well as the shift register unit 106 also being depicted in FIG. 4 for ease of understanding.

The analysis prediction unit 200 is envisaged to establish in advance—i.e. in anticipation of shifting the next tuple to be processed into that part of the shift register 106 where the bit modeling unit 108₁ expects the tuple which is to be processed, which location is depicted hatched in FIG. 4—which of these magnitude bits belong to pass 1. The analysis/prediction unit 200 makes this decision, for example, whenever the shift register unit 106 is refilled by the bit extractor 104 (FIG. 3), i.e. with each shift pulse. For example, in FIG. 4 the analysis prediction unit 200 makes the decision on the membership or non-membership of the magnitude bits of the vector of 4, qₘ, rₘ, sₘ, tₘ, which during the next shifting operation in the register unit 106 become the current tuple or are shifted to the hatched register area, where magnitude bits iₘ, jₘ, kₘ, and lₘ are currently located. To be able to make the prediction, the analysis/prediction unit 200 is coupled to register cells of the register unit 106, specifically to the part 106₂, which relates to the magnitude bits, as is indicated by an arrow 226, and to the part 106₃, which relates to the first status bits, as is indicated by an arrow 228, the first status bits indicating the significances of respective coefficients with regard to the current bit plane, as will be discussed below in more detail.

An output of the analysis/prediction unit 200 is followed by the register 218 so as to obtain, from the analysis/prediction unit 200, the result of the prediction in the form of a 4-bit vector which comprises, per magnitude bit of the tuple which is the next one to be current, a respective bit iₐₑ, jₐₑ, kₐₑ, and lₐₑ, which indicates whether or not the respective magnitude bit qₘ, rₘ, sₘ, or tₘ will have to be processed by the bit modeling unit 108₁ during the subsequent shifting cycle.

Both an input of the multiplexer 216 and an input of the coefficient selector 222 are coupled to the register 218. The coefficient selector 222 is configured to select, on the basis of the register content of the register 218, the magnitude bits of pass 1 which are to be modeled and/or to be precoded, and to communicate this selection, in the form of a multiplexer control signal, to the multiplexer 210, 212, 204, 206, and 216, and/or to the demultiplexer 214. The analysis/prediction unit 200 further outputs a prediction concerning the number of magnitude bits, which belong to pass 1, in the tuple to be processed next, specifically to the clock counter 220, which thereby is pre-initialized, at the beginning of each shifting cycle or after a shifting operation within the shift register 106, to a value which corresponds to the number of magnitude bits in the current magnitude bit tuple which belong to pass 1. Subsequently, the clock counter 220 decrements its counter contents, for example, on the basis of a processing clock which it obtains from the coefficient selector 222 which, in the processing clock, successively adjusts the multiplexer signal to the magnitude bits belonging to pass 1, as are indicated in the register 218.

The multiplexer 216 is configured to output, depending on the multiplexer signal from the coefficient selector 222, the bit indicated by the multiplexer signal as a validity bit from the register 218 to its buffer 110₁. On the input side, the multiplexer 204 is coupled to specific register cells or register locations of the shift register unit from the part 106₂ for the magnitude bits and is configured to couple, depending on the multiplexer control signal from the coefficient selector 222, one of the magnitude bit register cells which stores the bit indicated by the multiplexer signal to an input of the magnitude bit precoding unit 202 and, optionally, to an input of the sign bit precoding unit 208 in that a respective one of the inputs of the multiplexer 204 is guided to a respective output of the multiplexer 204. The same also applies to multiplexers 210, 212, and 206. For example, the multiplexer 210 is coupled, on the input side, to specific sign bit cells from the part 106₁ of the shift register unit 106, and is configured to output, depending on the multiplexer signal, a respective subset of said register contents or sign bits to a further input of the sign bit precoding unit 208 via the output of the multiplexer 210. Similarly, the multiplexer 212 is connected between specific register cells from the part 106₃ for the first status bits of the shift register unit 106 and a further input of the sign bit precoding unit 208 and the multiplexer 206 is connected between specific register cells in the part 106₃ of the shift register unit 106 and a further input of the magnitude bit precoding unit 202, so as to output, depending on the multiplexer signal, some of the first status bits of said specific register cells to the respective unit.

The signals which come in in this manner are used by the precoding units 208 and 202 to output one pair each of data bits 230 and 232, respectively, and a context index consisting of 2 bits 234 and 236, respectively, the data bit indicating the bit value of the sign bit or of the magnitude bit of the transformation coefficient which is indicated by the multiplexer signal and is currently to be processed, while the context index points to the associated context to be used in each respective case.

As is indicated in FIG. 4 by an arrow 238, provision may be made for the sign bit precoding unit 208 to additionally use, in its coding or context formation, a bypass mode bit 240, which is output by the control bit controller 224 in addition to an end-of-pass bit 242. The meaning of said control bits 240 and 242 will be explained in more detail below. Bits 230, 242 together form a 12-bit word 244, which is input into the buffer 210₁. The buffer 110₁ may be configured to buffer only data words 244, for which the validity bit 246, which comes in at the same time and is output by the multiplexer 216, indicates that the current multiplexer signal pointed to a magnitude bit which belongs to pass 1.

As may also be seen in FIG. 4, the data bit 232 output by the magnitude bit precoding unit 202 is fed back to an input of the demultiplexer 214. The latter is coupled, on the output side, to register cells from the area 106₃, namely those containing the first status bits for the current magnitude bits (shown in hatching), so as to employ, depending on the multiplexer signal, the data bit 232 for updating the first status bit which is associated with the magnitude bit that has just been modeled by the magnitude bit precoding unit 202. In this manner, the significance of the corresponding coefficient is updated.

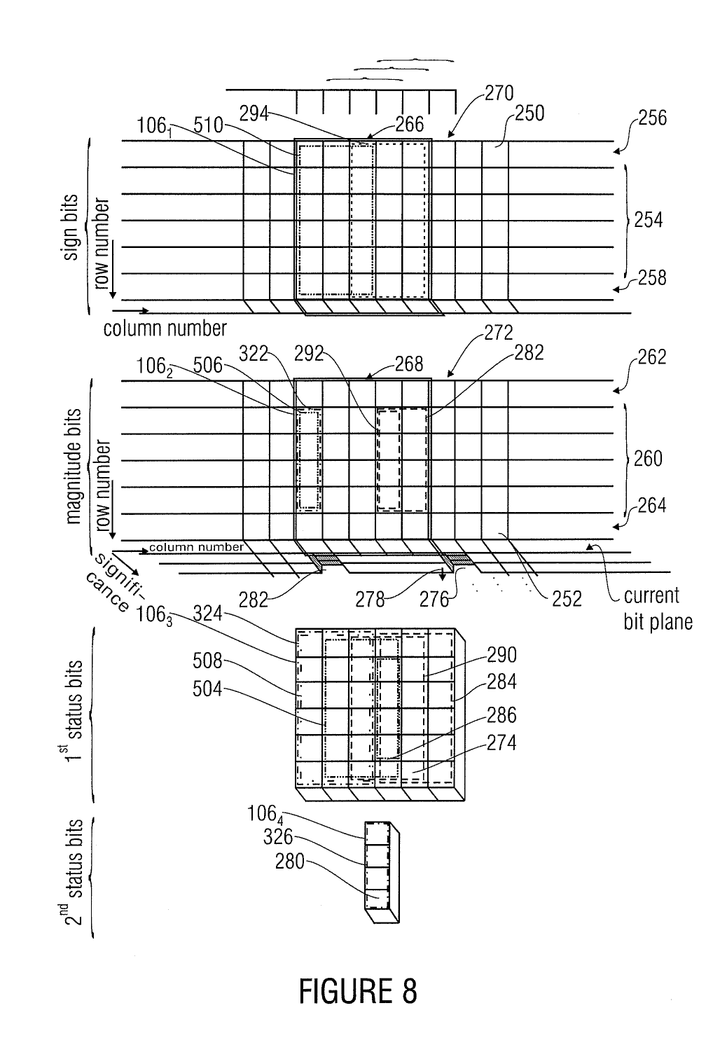

The previous description only roughly addressed the architecture and the mode of operation of the individual components of the bit modeling unit 108₁. This is why, in the following, the interaction of the individual components of the bit modeling unit 108₁ is to be explained in more detail in terms of interaction with the shift register unit 106, the buffer 110₁ and the bit extractor 104 while referring to FIGS. 8 and 3. FIG. 8 represents a section of the memory unit 102 (FIG. 3), specifically a section of the magnitude bits and sign bits of the transformation coefficients of a code block currently to be coded. In particular, the individual sign bits and magnitude bits are represented by cubes 250 and 252, respectively. In particular, the sign bits 250 are depicted to be arranged adjacently in rows and columns, as corresponds to the respective transformation coefficients in the code block to be coded. Only one section of the sign bits 250 is shown, specifically a section of sign bits 250 in a current stripe 254 plus the adjoining rows 256 and 258 of the stripes thereabove and therebelow. The magnitude bits 252 of the current bit plane are also depicted to be adjacent to one another in rows and columns, also merely a part, or a section, of the current bit plane being represented, said part or section corresponding to the part of the sign bit plane, i.e. to a part of a respective stripe 260 with the magnitude bits 252 of the rows 262 and 264 located thereabove and therebelow. Only for completeness' sake shall it be noted that magnitude bits and sign bits, which are mutually aligned in the vertical direction, in mutually corresponding rows 254-264 in FIG. 8 are to belong to identical transformation coefficients.

The magnitude bits of less significant bit planes than the current bit plane are not depicted in FIG. 8. Such magnitude bits of the more significant bit planes which are more significant and, thus, already coded, may be recognized in FIG. 8, however, and are located behind the current bit plane one after the other.

As was already described above, the bit extractor 104 in each shifting operation of the shift register unit 106 refills the latter, by means of memory accesses 114 (FIG. 2) with sign bits 250 or magnitude bits 252 from the memory unit 102, FIG. 3, so that a section of the sign bit plane or of the current magnitude bit plane is located in the shift register 106 at any time. These sections are depicted in a highlighted manner at 266 and 268 in FIG. 8. As may be seen, at a point in time contemplated, a section of the sign bit array of five successive columns and six superimposed rows, namely the four rows of the current stripe 254 and the adjacent rows 256 and 258, is located in the part 106₁ of the shift register unit. Accordingly, a section of the current magnitude bit plane of a length of four columns comprising six rows 260-264 each is located within the part 106₂ of the shift registers 106.

As may be seen in FIG. 8, sections 266 and 268 of the sign bits 250 or magnitude bits 252 stored in the rows 106₁ and 106₂ of the shift register unit 106 are mutually aligned such that for a transformation coefficient, for which instantaneous magnitude bits 252 are temporarily stored within the part 106₂, the respective sign bit 250 of the respective transformation coefficient is also temporarily stored within the part 106₁. In particular, a register cell is provided within the shift register unit for each bit to be stored, which register cell may also be considered as being represented, in FIG. 8, by the cubes in the respective portions 266 and 268. The register cells of the parts 106₁ and 106₂ are interconnected such that the register contents in FIG. 8 are shifted from the right to the left, so that with each shifting operation a column of sign bits 250 or magnitude bits 252 leaves the shift register unit 106 on the one side, specifically on the left-hand side in FIG. 8, and at the other end of the shift register the corresponding parts 106₁ and 106₂ are filled up with a next column 270 or 272 of sign bits 250 or magnitude bits 252. In FIG. 8, this corresponds to virtually shifting the temporarily stored portions 266 or 268 within the sign bit plane or magnitude bit plane to the right by one column per shifting operation. The bit extractor 104 is configured such that it performs filling up parts 106₁ and 106₂ with sign bits 250 or magnitude bits 252 which relate to a mutually associated column of transformation coefficients, so that the offset between the content of the sign bit the part 106₁ and the instantaneous content of the magnitude bit content 106₂ of the shift register unit 106 results at the rear shift register end, where sign bits are temporarily stored in the part 106₁ which leave said part at the next shifting operation, and for which no more magnitude bits are temporarily stored within the part 106₂.

As was already mentioned above, the bit modeling units 108₁ and 108₂ also may use status bits for their processing, specifically first and second status bits. The first status bits indicate, for a transformation coefficient in each case, whether or not same is significant with regard to the current magnitude bit plane. It shall once again be noted that the state of significance of the current magnitude bit plane for a transformation coefficient may change after or during the virtual first pass 1. The part 106₃ of the shift register unit 106 is dimensioned such that it stores one status bit 274 for six successive columns of transformation coefficients in rows which correspond to the rows 260-264, which are also depicted as cubes in FIG. 8. In particular, at any point in time the shift register unit 106 stores, within the part 106₃, first status bits 274 for transformation coefficients of six adjacent columns comprising six rows in each case, five of which columns contain the first status bits for transformation coefficients for which the sign bits 250 are contained in the section 266 of the part 106₁. In addition, first status bits for transformation coefficients are contained in a column of 6 of transformation coefficients, with whose sign bits 250 or magnitude bits of the current bit plane the parts 106₁ and 106₂ of the shift register unit 106 are not filled until the next shifting operation.

In the representation of FIG. 8, the cubes 274 may also be considered, at the same time, as being the corresponding register cells which are interconnected such that they shift their contents on a column-by-column basis, specifically, in FIG. 8, also from the right to the left and at the same clock as the other parts 106₁ and 106₂. The filling operation is also performed by the bit extractor 104, specifically by means of bit combination, such as a logic OR between bits which are arranged in a line in the direction of significance, on the basis of the magnitude bits 276, highlighted by hatching, within the more significant magnitude bit planes than the current magnitude bit plane for transformation coefficients which are located at the positions of column 272, with whose magnitude bits of the current bit plane the register cells are filled, at the front end of the part 106₂ of the shift register unit 106, not before the next shifting pulse. The filling operation, which has led to the most recent entries in the first-status bit part 106₃, is indicated by the arrow 278 in FIG. 8.

Finally, the shift register 106, too, has a the part 106₄ provided therein which has second status bits stored therein whose significance and relevance will become apparent from the description which follows. At any rate, the part 106₄ stores the second status bits for transformation coefficients of only one column and, specifically, in only four rows, which correspond to the rows of the stripe 260 or 254, the second status bits also being represented as cubes which are designated by the reference numeral 280. During each shifting operation in the shift register unit 106, the second status bits 280 are updated such that they are defined for the transformation coefficients whose magnitude bits are stored, in the output-side column, within the stripe 260, so as to be displaced from the part 106₂ of the shift register unit 106 during the next shifting operation. The bit extractor 104 updates the second status bits 280 at each shifting operation of the shift registers 106 from magnitude bits 282, highlighted by hatching, within more significant magnitude bit planes than the current magnitude bit plane for the transformation coefficients which have just been mentioned within the stripe 260, in that the bit extractor 104 verifies the respective magnitude bits, for each transformation coefficient, as to whether at least two of said magnitude bits are one, or are significant.

Returning back to FIG. 4, the analysis/prediction unit 200 is coupled to the parts 106₂ and 106₃ of the shift register unit 106 such that it obtains, for predicting the magnitude bit membership of the next magnitude bit tuple to be modeled, the content of the register cells from the part 106₂ as well as the first status bits in those register cells of the part 106₃ of the shift register unit 106 which are indicated by dashed lines and designated by reference numerals 282 and 284, respectively. To illustrate this in a little more detail, specifically addressed register cells or bits in the parts 106₁-103₄ will each be provided with an index pair #,# in the following, which indicates the register cell position or bit position in a manner in which it is coded, in terms of the column number and row number, from the top left corner. For example, the area 282 spans, for example, the area of the magnitude bits 252_{3,2} to 252_{4,5}, and the area 284 spans the area of the bits 274_{4,1} to 274_{6,6}. The analysis/prediction unit 200 uses the information supplied to it for predicting the membership of the magnitude bits at the positions 252_{4,2} to 252_{4,5} with the first pass, which magnitude bits form the tuple to be processed next, which, at least in the case that the magnitude bits include a magnitude bit belonging to pass 1, is processed by the precoding units 202, 208.

The magnitude bits in the area 282 are employed by the analysis/prediction unit 200 to be able to take into account that not all of the status bits in the second area 284 are updated in such a way as they will be in the case of the decoding within the decoder at the same position during the decoding of pass 1. In addition to its prediction, the analysis/prediction unit 200 uses the most recent prediction result which was output by it to the registers 218 and in which the shift register memory state of FIG. 8 relates to the transformation coefficient positions which are marked by the dash-double-dotted line 286 in the part 106₃, and which at the same time also mark the transformation coefficient positions which correspond to the tuple currently to be modeled. For example, the analysis/prediction unit 200 may take into account a state of the first status bit 274_{4,2} not yet being updated as a function of an AND operation of the bit iₐₑ of the most recent prediction result with the magnitude bit 252_{3,2}, in that it performs an OR operation on the result of this AND operation and the first status bit 274_{4,2}.

For the first status bit 274_{5,2}, the analysis/prediction unit 200 may address the state of not yet being updated in that it performs an AND operation on the result of an OR operation of eight direct adjacent bits 274 with a specified updating compensation for the status bits 274_{4,2} and 274_{4,3} with the magnitude bit 252_{4,2}. With first control bits which are virtually updated in such a manner, the analysis/prediction unit 200 may determine the membership of, for example, the magnitude bit 252_{4,3} by performing an OR operation of the first eight control bits of the eight immediately adjacent coefficients while subsequently performing an AND operation with the inverse, or the negation, of the status bit 274_{5,3}. In this manner, the analysis/prediction unit 202 consequently verifies for each of the magnitude bits 252_{4,2} to 252_{4,5} to be modeled whether the respective transformation coefficients which they represent are still insignificant, and whether the directly adjacent coefficients are already significant, or if at least one of same is already significant, specifically as early as a column prior to the column 252_{3,2} to 252_{3,5} which are currently to be modeled, and while taking into account the levels of significance as would have resulted in the case of proper traversing of pass 1 up to the respective magnitude bit in 252_{3,2} to 252_{3,5}.

Subsequently, the analysis result is output by the unit 200, as was already described, to the register 218 as a 4-bit vector, so as to be present at the input of the multiplexer 216, or of the coefficient selector 222 after the next shifting operation into the shift register unit 106. With only one additional arithmetic adding operation among the bit values output by same to the registers 218, the analysis/prediction unit 200 may also provide the prediction result and output it to the bit counter 220 before the start of the next shifting operation into the shift register unit 106, the result indicating the number of magnitude bits in the tuple to be modeled next which belong to pass 1. If the register 218 indicates that none of the magnitude bits of the current tuple 252_{3,2} to 252_{3,5} belongs to pass 1, the coefficient selector 222 will adjust the multiplexer signal at random, for example to a predetermined value which does not depend on the register content of the register 218, as a result of which the multiplexer 216 will output one of the non-set bits in the register 218 to the buffer 210₁ as a validity bit 246. Therefore, even if the precoding units 202, 208 and the control bit controller 224 together form a 12-bit word 244 and output same to the buffer 110₁, the buffer 110₁ will not perform, for example, temporary storage of said data word 244, because the validity bit has not been set. To save power, however, provision may be made for that, for example, the operation of the precoding units 202, 208 is inhibited in such a case, as is indicated, by way of example, by an arrow 288 in FIG. 4. Of course, it would also be possible that the buffer 110₁ performs storing of the data words 244 irrespective of whether or not the validity bit is set, in which case the buffer 110₁ simply temporarily buffers the validity bit along with the 12-bit word, this approach requiring a larger memory space within the buffer 110₁, however.

Otherwise, however, i.e. in the event that at least one bit is set in the register 218 that indicates that the corresponding magnitude bit among the magnitude bits 252_{3,2} to 252_{3,5} which are currently to be modeled belongs to pass 1, the coefficient selector 222 will sequentially adjust, in successive operating cycles, the multiplexer signal, in accordance with the set bits in the register 218, to the coefficients which belong to pass 1. In the processing clock, the control bit controller 224 and the precoding units 202 and 208 then generate, for each of these magnitude bits which belong to pass 1, a 12-bit data word 244 which, together with a set validity bit 246, is output to the buffer 110₁, which stores said data words in the order of their arrival on the basis of the set validity bit. In particular, the coefficient selector 222 passes through the magnitude bits belonging to pass 1 within columns 252_{3,2} to 252_{3,5} from top to bottom, as is expected by the decoder in accordance with the scan sequence.

In each processing cycle, the precoding units 202 and 208 process the information available to them in accordance with a respective coding scheme so as to determine the data bits 230 and 232, respectively, and the associated context indices 234 and 236. The precoding unit 202 performs a so-called significance propagation, or SP, coding scheme. In accordance with said scheme, the context index 236 is formed by means of performing a logical operation of the significances of the adjacent coefficients. That is, for example, if the current multiplexer signal points to the magnitude bit 252_{3,3}, the multiplexer 206 will forward the first status bits 274_{3,2} to 274_{5,2}, 274_{3,4} to 274_{5,4}, 274_{3,3} and 274_{5,3}. Overall, the multiplexer 206 is consequently coupled, on the input side, to the register cells which are surrounded by the dashed line 290 in FIG. 8. On the input side, the multiplexer 204 is coupled to the register positions in the area 106₂, which corresponds to the tuple currently to be modeled and is marked by a dashed line 292. The multiplexer 204 outputs the magnitude bit value, which is indicated by the multiplexer signal, to the precoding unit 202 so that same may adjust the data bit 232 accordingly.

As is indicated in FIG. 4 by the dashed connecting line 294, the sign bit precoding unit 208 may also obtain the magnitude bit value of the magnitude bit indicated by the multiplexer signal, so as to inhibit or perform processing in dependence thereon. For on the decoder side, the decoder expects coding of the sign bit of a transformation coefficient only when it becomes significant for the first time, namely directly after obtaining the corresponding data bit of this magnitude coefficient, so that in this case, in the data word 244, the respective bits 230 and 234 are not significant. The data bits and context indices 230, 234 which are output by the unit 208 are only relevant, in other words, when the data bit 232, which is output by the magnitude precoding unit 202, is significant, or is set. The connection 294 between the output of the multiplexer 204 and the precoding unit 208 may also be missing, however, in which case the values taken on by the data bit 230 and/or the context index 234 are insignificant for the subsequent revision.

At any rate, the sign bit precoding unit 208 performs a so-called sign coding, or SC, scheme, according to which the data bit 230 is adjusted to the value of the sign of the transformation coefficient which is indicated by the multiplexer signal, and the associated context index 234 is adjusted to a context which depends on a logical interconnection of the significances and signs of the adjacent coefficients, specifically—in accordance with the JPEG2000 standard, which is addressed by way of example here—only the adjacent coefficients in the column and row directions. For example, if the multiplexer signal points to the magnitude bit 252_{3,3}, the precoding unit 208 will determine the data bit 230 from the sign bit 250_{4,3} and from the sign bits 250_{3,3}, 250_{5,3}, 250_{4,2} and 250_{4,4} which are adjacent thereto, while taking into account that not all of the sign bits are known for the decoder yet, which is taken into account here in that the first control bits of the adjacent bits are evaluated, namely 274_{3,3} and 274_{4,2}. Accordingly, the multiplexer 210 is coupled, on the input side, to register cells within the area marked by the dashed line 294, whereas the multiplexer 212 is coupled, on the input side, to some of the register cells within the area 290, so as to couple at least some of said register cells, depending on the multiplexer signal from the coefficient selector 222, to the sign bit precoding unit 208 in each case.

In each processing cycle of the precoding units 202 and 208, the control bit controller 224 sets the control bits 240 and 242, which are to inform the subsequent arithmetic coding means 112 (FIG. 3) for example about whether the bypass mode for the respective transformation coefficient of the data word 244 is to be active, and whether the current coding pass is completed. More specifically, the control bit controller 224 sets the end-of-pass bit 242 in the event that the tuple currently to be modeled encompasses the last magnitude bits within the current magnitude bit plane, e.g. in the example of FIG. 2, the magnitude bits uᵢ, vᵢ, wᵢ, and xᵢ within the current bit plane i. The control bit controller 224 adjusts the bypass mode bit 240 for example in dependence on the depth of the current magnitude bit plane, so that, e.g. after the fourth coded bit plane, the bit 240 will indicate the bypass mode, which indicates that, from this moment on, the pass 1 data are to be introduced in a raw state, or uncompressed, into the data stream at the output of the arithmetic coding means 112.

Finally, it shall also be noted that the buffer 110₁ will be configured, in particular—in the event that it is configured to temporarily store or to discard data words 244 in dependence on the validity bit 246—such that the buffer 210₁ will temporarily store the data word 244—in the event of an end-of-pass bit 242 being set—even if the corresponding validity bit 246 is not set. In this case, various measures may be provided for that the data word reflects the actual non-set validity bit 246, such as coding the remainder of the data word 244, except for the end-of-pass bit, into a state which is otherwise invalid, since it does not come up with any magnitude bits which belong to pass 1.

As was already mentioned, the clock counter 220 is pre-initialized, after each shifting operation, to the prediction as to how many coefficients within a column are modeled or are to be modeled. Since this prediction is already performed one column before the column currently to be modeled, the result will already be available to the clock counter 22 as early as in the shifting operation itself. If the result, or the pre-initialization, is 0 or 1, the next shifting operation of the shift register unit 106 may immediately be initiated at the next clock, which the clock counter 220 will prompt accordingly. With larger pre-initialized values, the clock counter 220 delays, accordingly, the shift pulse 296 being output to the shift register unit 106. As will also be mentioned below, in this context the clock counter 220 also takes into account whether the parallel processing by the bit modeling units 108₂ and 108₃, respectively, has progressed sufficiently. The prediction result with regard to the number of associated magnitude bits is formed, as was mentioned above, by means of a logical interconnection from the 4-bit vector for the register 218 and the significance status variables.

Even though this was already mentioned above, it shall once again be emphasized how the updating of the first status bits by means of the demultiplexer 214 is effected. As was already mentioned, the first status bits 274 indicate whether a transformation coefficient in question is already significant, or not, in relation to the current bit plane. Therefore, an update may also mean a transition from non-significant to significant. Coupling the data bit 232 via the demultiplexer 214 to the respective register cell within the area 286 of the part 106₃ of the shift register unit 106 is therefore advantageously configured such that the feedback leads to updating the instantaneous register cell state of the first status bit, which corresponds to the data bit 232, with a value which corresponds to a logical OR interconnection of the current state to the data bit 232. In addition, corresponding measures should be taken so that the data bit 232 will be 0 if the validity bit 246 is not set. In other words, the demultiplexer 214 is coupled, on the output side, to the register cells within the area 286, and is configured to couple, in dependence on the multiplexer signal from the coefficient selector 222, the data bit output of the precoding unit 102—in the manner of the previously described OR operation—to the respective first-status bit register cell of the transformation coefficient indicated by the multiplexer signal.

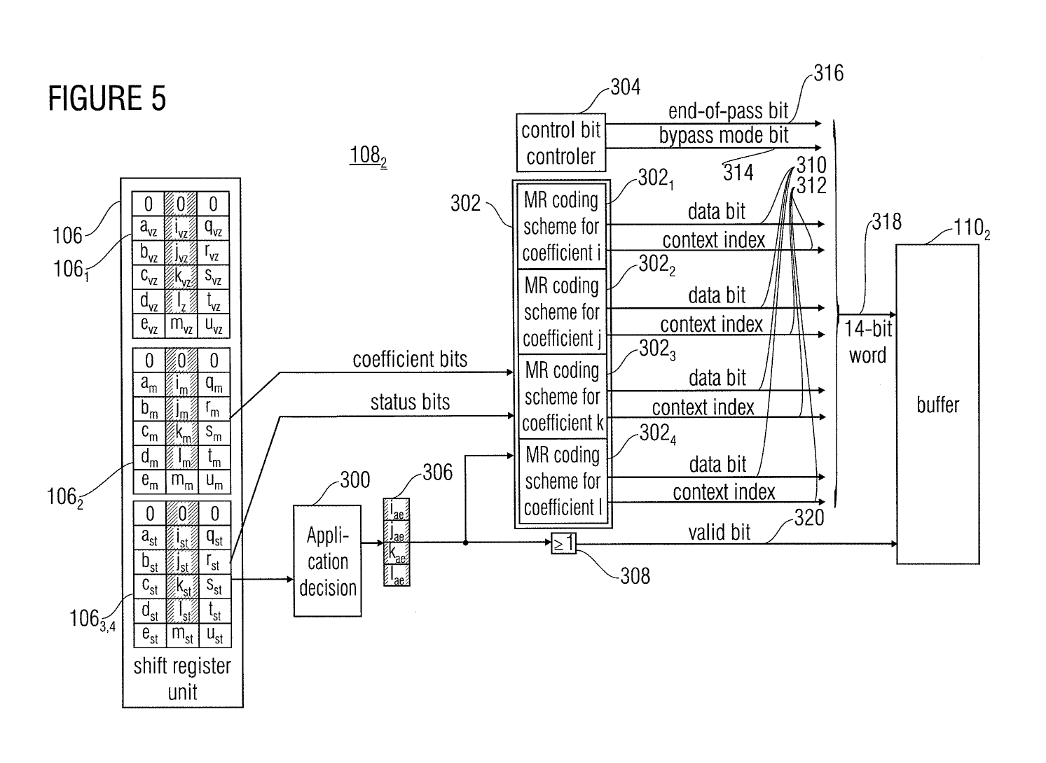

Now that the mode of operation of the bit modeling unit 108₁, which is responsible for the first coding pass, has been described, a description will be provided below of the mode of operation of the bit modeling unit 108₂, which is responsible for the second coding pass, for which purpose reference is made to FIG. 5. Unlike the first coding pass 1, the second coding pass 2 is responsible for magnitude bits which belong to such transformation coefficients which are already significant. In accordance with the JPEG2000 coding scheme, the second coding pass is also referred to as a magnitude refinement pass, which is relevant to magnitude bits which belong to coefficients which are already significant prior to any coding pass of the current magnitude bit plane, but which precisely do not become significant only because of the first pass. This means that the decision on the membership of a magnitude bit with the second coding pass should be made on the basis of the status bits in that the part 106₃ of the shift register unit 106 which has not yet been updated by the feedback via the demultiplexer 214 within the memory 286, i.e. on the basis of the first status bits in register cells on the right-hand side thereof, seen from the perspective of FIG. 8. However, conversely, contexts of the magnitude bits which belong to the second pass are determined, as will be described below in more detail, on the basis of the first updated status bits, which is why the bit modeling unit 108₂ and the bit modeling unit 108₃, which was described subsequently to same, perform the modeling with regard to such magnitude bits which come at a sufficient distance, in temporal terms, after the magnitude bits of the bit modeling unit 108₁ which are currently being modeled, in units of the shift register ranks. In the presently described exemplary case, a fixed offset of two shift pulses shall be assumed, by way of example, even though this offset may also be variable, while keeping to a minimum distance, such as the two shift register ranks.

FIG. 5 shows the architecture of the bit modeling unit 108₂ in accordance with an embodiment of the present invention. By analogy with FIG. 4, it is again shown together with the shift register unit 106 and the associated buffer 110₂. The bit modeling unit 108₂ comprises an application decider 300, a precoder 302, a control bit controller 304, a 4-bit register 306, and a sum threshold value decider 308. On the input side, the application decider 300 is coupled to the part 106₃ of the shift register unit 106, and on the output side, to the 4-bit register 306. Both an input of the precoder 302 and an input of the sum threshold value decider 308 are coupled to the register 306. On the input side, the precoder 302 is also coupled to the parts 106₂, 106₃, and 106₄ of the shift register unit 106. Internally, the precoder 302 comprises four magnitude bit precoding units 302₁ to 302₄, which are designed to correspond to one another, one for each magnitude bit of the current tuple, said units also being represented in hatching in FIG. 5. Each of the precoding units 302₁ to 302₄ comprises an output 310 for a data bit and a 2-bit output 312 for a context index. The control bit controller 304 comprises an output 314 for an end-of-pass bit, and an output 316 for a bypass mode bit, the outputs 310 to 316 together defining a 14-bit output for a 14-bit word 318, said output being coupled to an input of the buffer 110₂. An output of the sum threshold value decider 308 is also coupled to a further input of the buffer 110₂ so as to output a validity bit 320 to the buffer 110₂.

Now that the architecture of the bit modeling unit 108₂ has been described, its mode of operation will be described below. The application decider 300 is configured to form on the basis of its input information in the register 306 an information bit iₐₑ, jₐₑ, kₐₑ, and lₐₑ, for each magnitude bit to be currently modeled, said information bit indicating whether or not the respective magnitude bit belongs to pass 2 so as to write same into the register 306 in such a manner that it is delayed by a suitable number of shift pulses of the shift register unit. The delay is due to the fact that the precoder 102 is coupled, on the input side, to register cells of the magnitude bit part 106₂ of the shift register unit 106 which is connected downstream from the register positions of the magnitude bits for which the application decider 300 currently evaluates the first control bits, the former register positions within the part 106₂ being marked by a dash-dotted line 322. In particular, on the input side, the precoding unit 302₁ is coupled to the register cell 252_{1,2} and, within the register 306, to the entry iₐₑ, the precoding unit 302₂ is coupled to the register cell 252_{1,3} and the bit jₐₑ of the register 306, etc. Thus, each of the precoding units 302₁ to 302₄ is responsible for a different one of the magnitude bits in the column of 4 322 currently to be modeled.

Each precoding unit 302₁ to 302₄ adjusts its data bit in accordance with its magnitude bit from the cells 322. They determine the context index in dependence on the updated significances of the adjacent coefficients, for which purpose the precoder 302 is coupled to the register cells of the part 106₃ of the shift register unit 106, which is marked by a dash-dotted line 324 in FIG. 8. In particular, e.g., the precoding unit 302₁ is coupled to the register cells 274_{1,1} to 274_{3,1}, 274_{1,3} to 274_{3,3}, 274_{1,2} and 274_{3,2}, which thus relate to coefficients which surround that one of the magnitude bit 252_{1,2}. In particular, each coding unit 302₁ to 302₄ specifies its context index 312 by means of a formation from a logical interconnection of the first control bits 274 of these adjacent coefficients. However, if the associated entry in the register 306 of the respective precoding unit 302₁ to 302₄ should indicate that its respective magnitude bit does not belong to pass 2 at all, said precoding unit will set the context index bits 312 to a bit combination which does not correspond to any meaningful context index, and which thus reveals, of its own accord, that the data bit 310, which is associated accordingly, is invalid.

In addition, the precoder 302 is coupled to the register cells 280 from the part 106₄ of the shift register unit, in particular, each precoding unit 302₁ to 302₄ is coupled to the respective register cell for the second status bit, which is associated with the respective magnitude bit. In this context, the precoding units 302₁ to 302₄ are configured such that their context indices 312 output by them are dependent not only on the logical interconnection that has just been described, but also on the respective second status bit, i.e. on whether or not the transformation coefficient in question already possessed a magnitude bit within the preceding, more significant magnitude bit planes, which magnitude bit traversed the second coding pass 2. Coupling of the precoder 302 to the register cells of the part 106₄ is indicated by the dash-dotted line 326 in FIG. 8.

For example, the control bit controller 304 adjusts the bypass mode bit 316 in a similar manner as was described above with reference to the controller 224. The same applies to the end-of-pass bit 314. The control bit controller 304, too, consequently sets the control bits 314 and 316 to provide the subsequent arithmetic coding means with information which indicates whether the so-called bypass mode is to be active, or whether the current coding pass is completed.

As was already mentioned, the bits 310-316 form the data word 318. For example, the buffer 310₂ is configured to receive the 14-bit word 318 into the buffer only when the validity bit 320 is set, except for the event that the end-of-pass bit 314 is set, in which case the data word 318 is stored into the buffer 310₂ at any rate. The combination of the validity bit and the 14-bit word 318 into a larger data word including a storage at any rate is also possible, of course, as an alternative, as was already described with reference to FIG. 4.

The sum threshold value decider 308 sums the bits in the register 306 and verifies whether the sum is larger than or equal to 1, so as to adjust the validity bit 320 in accordance with the verification result, and so as to thereby set the validity bit if at least one of the magnitude bits in the current tuple which are currently to be modified belongs to pass 2.

Consequently, the bit modeling unit 108₂ is able to precode those magnitude bits within a current tuple 322 which belong to pass 2 into a data word 318 in a processing cycle. Said pairs themselves reveal the number of pairs of data bits and context indices that are actually valid in the 14-bit data word 318 and/or are to be introduced into the data stream to be coded at the output of the arithmetic coder 124 (FIG. 3), in that said pairs in the negative case have a specific bit combination which is no valid combination of data bit and context index, or is no valid context. From that point of view, the bit modeling unit 108₂ may use no shift pulse output capability, since it is at least as fast as the described bit modeling unit 108₁, which may use at least one processing cycle per magnitude bit belonging to pass 1.

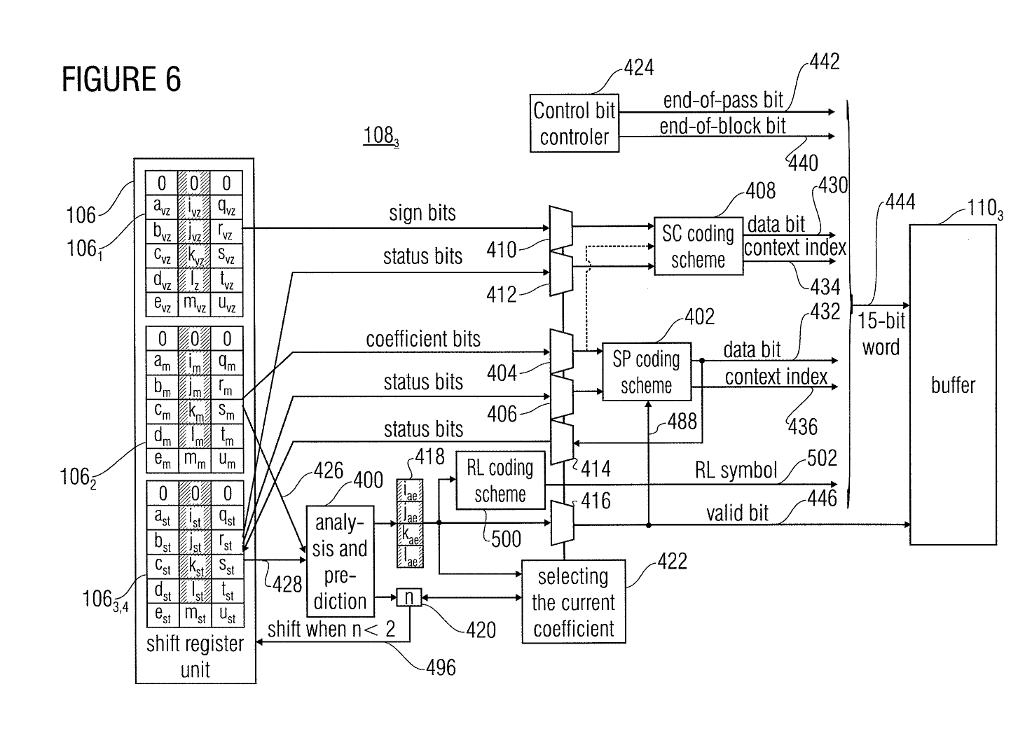

What follows is a description of the architecture and mode of operation of the bit modeling unit 108₃ for the third coding pass. Reference shall be made to FIG. 6 in this context. With regard to the blocks and their mutual coupling, the architecture is similar to the case of the bit modeling unit 108₁ of FIG. 4. To avoid unnecessary repetitions, elements which basically have the same tasks as elements of FIG. 4 are provided, in FIG. 6, with reference numerals which differ from those of FIG. 4 only by the first digit, or the centesimal place, specifically such that they have a four instead of a two. In particular, all of the elements of FIG. 4 are also depicted in FIG. 6, except that the buffer shown in FIG. 6 naturally is the buffer 110₃, except that the control bit controller outputs, in addition to the end-of-pass bit 442, an end-of-block bit 440 rather than an end-of-bypass bit, and except that the sign bit precoding unit 408 comprises no coupling to the control bit controller 424. Differences in the functionality and the exact wiring with the shift register unit 106 of the mutually corresponding elements in FIGS. 4 and 6 may be gathered from the description which follows, so that descriptions of functionality, which will be explained below, are to replace respective descriptions of functionality relating to the corresponding elements with reference to FIG. 4. In addition, reference shall be made to the description of FIG. 4 as far as functionality and wiring are concerned.

In addition to the elements mentioned above, the bit modeling unit 103₃ comprises a run-length coding unit 500 which has an input which is coupled to the register 418, and an input which is coupled to a further output of the analysis/prediction unit 400. An output of the run-length coding unit 500 is provided for outputting a run-length symbol 502 having three bits, so as to form, along with the other output bits 430-436 and 440, 442, the data word 444 which enters the buffer 110₃, which thus is a 15-bit data word 444.

The third coding pass for which the bit modeling unit 108₃ is responsible becomes important when the coefficient to be modeled is still insignificant to the current bit plane and has not yet been captured by the first pass. It is therefore also referred to as a “clean-up pass”. With regard to context formation and precoding, the mode of operation of the third coding pass is similar to the first pass, but is expanded by a so-called run-length (RL) primitive. In other words, the third coding pass is responsible for the remaining magnitude bits which belong neither to the first nor to the second coding passes, the coding of the pass-3 magnitude bits being performed in the current column of 4, just like in the case of pass 1, with the exception that in the event that all of the magnitude bits in the current column of 4 are associated with a transformation coefficient which is not yet significant, and comprise only insignificant adjacent coefficients, the run-length mode sets in which indicates, from top to bottom, the run of such magnitude bits in the current tuple which remain insignificant, and is thus interrupted only if one of the magnitude bits of the current column of 4 within the current bit plane becomes significant, or exhibits a magnitude bit value of 1, whereupon the subsequent magnitude bits in this column of 4 are coded further, as in the case of pass 1, and the sign of the coefficient which interrupts the RL primitive is coded.

Following this brief overview of pass 3, the mode of operation of unit 108₃ shall be explained, once again by combining FIGS. 6 and 8. Since, by definition, pass 3 is the last one among the sequential passes, the significance verifications each refer to those first status bits which have already been updated by the bit modeling unit 108₁, i.e. to the first status bits to the left-hand side of the area 286 in FIG. 8. While taking into account the verification of the adjacent coefficient significances, the area of the current column of 4 should be located at least two shift register ranks behind the current area 282 of the bit modeling unit 108₁. In accordance with the embodiment of FIG. 6, the current area is located precisely two shift register ranks behind said area. However, as was explained above with reference to pass 2, provision may also be made for the architecture of the shift register unit to be modified as compared to FIG. 8 so as to also enable a variable offset, so that the processing speeds of the two units 108₁ and 108₃ are decoupled.

Reference shall be made below to FIGS. 6 and 8 in combination so as to illustrate the mode of operation of the bit modeling unit 108₃. Again, the analysis/prediction unit 400 verifies, in advance, the tuple of 4 of magnitude bits 252_{2,2} to 252_{2,5}, which is provided for being modeled next within the unit 108₃, which of same belong to pass 3, i.e. which do not belong to pass 1 or pass 2, and to this end is coupled, via coupling 428, to register cells of the part 106₃ of the shift register unit 106, said shift register cells being surrounded by the line 504 in FIG. 8 which has 3 dots between each dash. Among these first status bits in the area 504, the status bits located within the area 286 may be updated, or one may consider the fact that same, possibly become significant during the first pass, for which purpose the analysis/prediction unit uses the previous prediction result—which was obtained with regard to the previous shifting cycle—of the analysis/prediction unit 200 of the bit modeling unit 108₁, as well as the magnitude bits in the associated area 292, for which purpose the analysis/prediction unit 400 is also coupled, via the coupling 446, to the register cells in the area 292. In addition, the analysis/prediction unit 400 uses, by analogy with the case of FIG. 4, its most recent prediction result for the prediction which obviously relates, for the current prediction, to the magnitude bits in the area currently to be modeled, specifically so as to take into account the updates of the significances in the positions 274_{2,2} to 274_{2,5} on account of the dedicated coding pass, i.e. of coding pass 3, which does not occur before the running shifting cycle, which is why the analysis prediction unit 400 is also coupled to further magnitude bit register cells within the area 106₂ of the shift register 106, namely to those of the current column of 4 within the area marked by the line 506 which has 3 dots between each dash. Just like in the case of FIG. 4, the analysis/prediction unit 400 outputs the prediction result to the register 418 for the next shifting cycle.

At the beginning of the shifting cycle—i.e. wherein the magnitude bits in the part 106₂ of the shift register unit 106 which have been predicted with regard to their membership with pass 3, have been advanced so as to represent the current magnitude bit tuple, together with the current magnitude bits to which the prediction in the register 418 refers and which it obtains from the analysis/prediction unit 400 in accordance with the example of FIG. 6—the run-length coding unit 500 evaluates the 4-bit vector in the register 418 so as to establish, for one thing, whether the run-length primitive is to be applied, i.e. whether all of the magnitude bits of the current tuple of 4 are associated with the third coding pass, and, if this is so, whether it is interrupted at any place—on account of a magnitude bit among them becoming significant—so as to adjust the run-length symbol 502 in dependence on this evaluation. From that magnitude bit on which becomes significant, i.e. all of the magnitude bits which follow the one becoming significant, down to the bottom end, including the one becoming significant—since, for the latter, the sign still remains to be coded into the coded data stream—are converted to a corresponding multiplexer signal by the coefficient selector 422, so that the coding units 402 and 408 will generate, in the above-described manner, respective pairs of data bits and context bits 430-436 for said magnitude bits. As was already mentioned above, the precoding units 402 and 408 to this end may use one processing cycle per magnitude bit. Therefore, only one data word 444 for a column of 4 is generated, by the bit modeling unit 108₃ in the case of run-length coding, only as long as there is no more than one magnitude bit among the four current magnitude bits which becomes significant. Otherwise, several 15-bit data words 444 are generated, the run-length symbol 502 indicating only in the first data word 444 that the run-length primitive has been applied, and otherwise the run-length symbol 502 indicates that it is insignificant.

Even though pass 3 is the last pass, the magnitude data bit 432 at the output of the precoding unit 402 is fed back, via the demultiplexer 414, to the part 106₃ of the shift register unit 106, specifically depending on the multiplexer signal from the coefficient selector 422, to the respective register cell within the column of 4 of register cells 274_{2,2} to 274_{2,5}. The reason for this is that, in the next shifting operation, wherein this column of 4 in FIG. 8 is shifted to the left by one position, is intended to be updated with regard to the significances. On the output side, the demultiplexer 414 is coupled to the register cells 274_{2,2} to 274_{2,5}. On the input side, the multiplexer 404 is coupled to the register cells within the area 506. On the input side, the multiplexer 406 is coupled to the register cells within the area 508, which encompasses the first status bits for an area surrounded by the current column of 4 of magnitude bits 506, including neighbor coefficients. The multiplexer 410 is coupled to the respective area of register cells within the area 106₁ of the shift register unit 106, which area 106₁ is highlighted at 510 in FIG. 8. On the input side, the multiplexer 412 is coupled to register cells within the area 508, specifically, for example, to register cells 274_{1,2} to 274_{1,5} and 274_{2,1} to 274_{2,4}.

In the specified manner, the bit modeling unit 108₃ consequently sees to it that the coefficients to be modeled are analyzed as to whether they are still insignificant, and that the direct adjacent coefficients are analyzed as to whether they are already significant, in such a manner that the analysis takes place already one column before the column currently to be modeled. The result of the analysis again is output as a 4-bit vector, specifically into the register 418, which vector is used as the basis for deciding whether the RL primitive is applied to the four current coefficients. If the condition is met, which is verified by the run-length coding unit 500, the validity bit will naturally also be set by the multiplexer 516, since each bit in the register 418 is set, and the coding unit 500 will perform the run-length coding scheme, which encompasses specifying the symbol 502 which represents whether the RL primitive has been applied, and, possibly, at which position a coefficient becomes significant. If at least one coefficient in the current tuple becomes significant, the associated sign bit will additionally be coded, by the precoding unit 408, for that magnitude bit which interrupts the run (bits 432 and 436 are insignificant in this processing cycle). For the bit positions which follow the magnitude bit interrupting the RL primitive, the precoding unit 402 performs the SP coding scheme, which was already described above, for each following coefficient in the current column, which encompasses specifying a data bit and a matching context index, which is formed by means of logically interconnecting the significances of the adjacent coefficients. When the data bit of the SP coding scheme, or the respective magnitude bit, at the respective bit position is set, which may be verified via the connection 494, the SC scheme will be performed for said subsequent bit positions by the precoding unit 408, which encompasses specifying a data bit and a matching context index, which is formed by means of logically interconnecting the significances and signs of the adjacent coefficients. The control bits 440 and 442 are set by the control bit controller 424, which communicates to the subsequent arithmetic coding means whether the current coding pass, or the current code block, has been completed. The latter applies, in the example of FIG. 2, e.g. to the tuple uₙ, vₙ, wₙ, xₙ. Data bits and context indices of the SP and SC schemes as well as of the symbol 502 and of the control bits 440 and 424 are combined into the 15-bit data word 444, which will be stored into the buffer 110₃ if the validity bit has been set, and in any case if the end-of-pass bit 442 has been set.

Naturally, the analysis prediction unit 400 also predicts how many coefficients will be modeled within one column, said prediction being made already one column before the column currently to be modeled, so that the result is already present in the shifting operation; if the result is “0” or “1”, the next shifting operation might immediately follow with the next clock, which the clock counter 426 communicates to the shift register unit 106. The prediction result is formed by means of logical interconnection from the four-bit vector and the significance status variables, as was described above, corresponding measures having been taken in the shift register unit 106 to the effect that the shifting operation is indeed performed only when both units 108₁ and 108₃ have forwarded their shift pulses to the shift register unit 106, so as to ensure that a shifting operation will not be started too early.

Now that the three bit modeling units 108₁ to 108₃ have been described, reference shall again be made briefly to FIG. 3 before the detailed description of the internal architecture of the pass decider 122 in accordance with an embodiment of the present invention is continued. As was described above, the three bit modeling units 108₁ to 108₃ process the magnitude bits of the current magnitude bit plane independently of one another, as far as possible, and, above all, in parallel with each other, in a common scan with a slight mutual offset. The data words are successively stored in each case in a dedicated one of the buffers 110₁ to 110₃. The buffers 110₁ to 110₃ are designed such that the sequence of the respective data words stored is maintained during readout. To this end, the buffers 110₁ to 110₃ may be configured as FIFO (first-in, first-out) memories, for example. Of course, other implementations are also possible, such as implementations as ring memories, but also directly addressable or content-addressable memories in the event of corresponding measures being taken for a suitable readout sequence, the memories not having to be present separately for each modeling unit accordingly.

The pass decider 122 decodes the data words in a suitable sequence and converts them to corresponding control signals for the arithmetic coder 124. In particular, the pass decider 122 initially reads out the data words of the first pass until said pass is completed, which is indicated by the end-of-pass bit, thereupon it reads the data words of the second coded pass from the buffer 110₂ for such time until the end-of-pass bit is set there, and then it reads the data words from the buffer 110₃ . . . . In this manner, the coding sequence as is actually expected by the decoder is kept to.

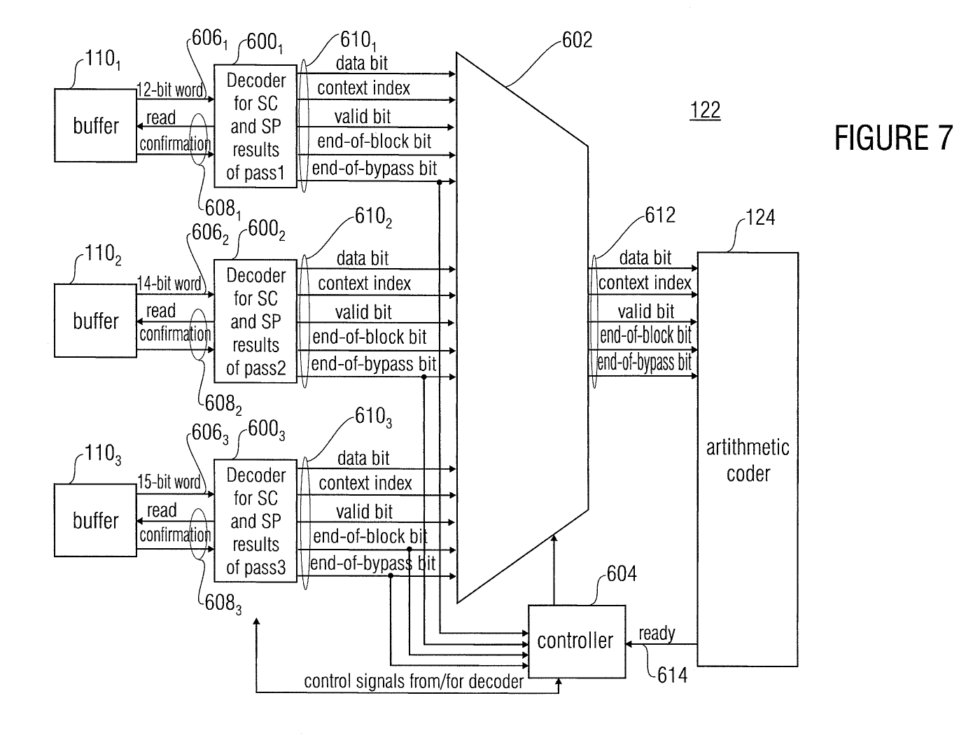

FIG. 7 shows the internal architecture of the pass decider 122 in accordance with an embodiment of the present invention in a state which is coupled, on the one side, to the arithmetic coder 124 and, on the other side, to the buffers 110₁, 110₂, and 110₃. In particular, the pass decider 122 of FIG. 7 comprises three data word decoders 600₁, 600₂, and 600₃, which are connected, on the one side, between a respective one of the buffers 110₁ to 110₃ and, on the other side, corresponding inputs of a multiplexer 602. In addition, the pass decider 122 comprises a controller 604.

A respective data word line 606₁, 606₂ and 606₃, respectively, is provided between each pair of buffers 110₁ to 110₃ and data word decoders 600₁ to 600₃ so as to read the next data word from the respective buffer. Request and confirmation signal lines 608₁ to 608₂ and 608₃ are also provided between said pairs so as to read out the data words in a handshake process. On the output side, each data word decoder 600₁ to 600₃ comprises five signal connections 610₁, 610₂ and 610₃ to respective inputs of the multiplexer 602. The signal connections 610₁ to 610₃ each comprise a data bit, context index, validity bit, bypass-mode bit and end-of-pass bit connection. In the case of the data word decoder 600₃, only the bypass-mode bit connection is replaced by an end-of-block bit connection. On the input side, the controller 604 is coupled to the end-of-pass bit outputs of the data word decoders 600₁ to 600₃ and to the end-of-block bit output of the data word decoder 600₃, respectively. The controller further comprises an output coupled to a control input of the multiplexer 602. In addition, the data word decoders 600₁ to 600₃ exchange control signals with the controller 604, which signals may serve to realize a handshaking process, for example. On the output side, the multiplexer 602 comprises six signal connections 612 to the arithmetic coder 124, namely the previously mentioned signal connections for data bit, context index, validity bit, bypass mode bit, end-of-pass bit and end-of-block bit. In addition, the arithmetic coder 124 is coupled to the controller 604 via a feedback path 614 so as to be able to communicate to the controller 604 whether it is again receptive for processing further data on the signal connections 612.

During operation, the data word decoders 600₁ to 600₃ successively read out the data words from the respective ones of the three buffers 110₁ to 110₃ and decode the data words. The data word decoder 600₁ codes the 12-bit data words back to one or two data bursts in each case so as to forward them, in one or two consecutive clocks, to the multiplexer 602 via the signal connections 610₁, namely a signal burst with the magnitude data bit and the associated context index for the coefficient bit modeling, as well as a further signal burst, when the magnitude data bit has been set, with a data bit which then indicates the sign, and the associated context index. If the data bit is valid, the decoder 600₁ will also set the validity bit. The decoder 600₁ derives the bypass mode bit and the end-of-pass bit on the signal lines 610₁ directly from the 12-bit data word.

The decoder 600₂ behaves similarly. It, too, decodes the data words from the buffer 110₂ back into data bits and context indices for modeling up to four coefficients so as to forward each 14-bit data word in the form of one up to four consecutive signal bursts on the signal lines 610₂ to the multiplexer 602. The data word decoder 600₃ behaves similarly in that it converts the incoming 15-bits data words from the buffer 110₃ back to run-length symbols, data bits and context indices for coefficient modeling and, if the data bit has been set, for sign bit modeling, and forwards them to the multiplexer 602 in one or two consecutive signal bursts on the signal lines 610₃. However, if the RL primitive becomes important, which may be gathered from the RL symbol, the data word decoder 600₃ performs the conversion to one signal burst—in the case of the entire run length or of no magnitude bit among only pass 3 bits which becomes significant—up to four signal bursts—in the case of a magnitude bit among only pass 3 bits which becomes significant, at the second position from the top within the tuple. The controller 604 evaluates the end-of-pass bits so as to consecutively connect, first of all, the signal lines 610₁ to the respective signal lines of the signal lines 612, then the signal lines 610₂ and then the signal lines 610₃. In this manner, the arithmetic coder 124 also obtains information, with each data bit and context index, as to whether the bypass mode is to be used for the respective coefficient, and whether the current coding pass or code block is completed. In the first-mentioned case, the arithmetic coder 124 interrupts its arithmetic interval subdivision and inserts the corresponding data bit—with the bypass mode bit being set—into the arithmetic data stream in clear text, and in the second case, the arithmetic coder resets its current interval back to the predetermined value, just like probability estimation values of the individual contexts in the event that the arithmetic coder is configured to be adaptive. By means of the above-described handshake connections, the flow of information within the pass decider 122 is controlled in dependence on whether the buffers 110₁ to 110₃ contain data and/or whether the arithmetic coder is ready to accept data.

The above-described block coder of FIGS. 3-8 may be realized in hardware, in which case it will represent a hardware-based JPEG2000 block coder, wherein the number of the process steps involved in context modeling is reduced due to the above-illustrated parallel processing and the pass membership prediction. Depending on the coding pass, either a coefficient bit was modeled at the same time with its sign bit, in one step, or a column of up to four coefficient bits was modeled at the same time, in one step, or a column of up to four coefficient bits was modeled in a so-called run-length primitive, in one step, said same step comprising modeling, together with its sign bit, that coefficient which becomes significant.

In addition, a prediction was provided as to how many coefficients may be modeled within one column in one step. With a clocked process, these measures effect, at the same clock frequency, coding of a coding pass in a shorter amount of time since periods of waiting for register set processes are omitted, since up to four coefficients may be modeled at the same time, since up to four modeling operations may be conducted in one step, since it is already known, at the beginning of a modeling operation of a column, how many coefficients may be modeled in one step, as a result of which time-consuming verification functions during modeling are dispensed with.

In addition, the bit extraction enabled a reduction, in the discrete status variables, which are to be logged and updated, for each coefficient of a code block, as a result of which the appropriate memory size may be reduced, on the one hand, and the coding of a coding pass may be accelerated, on the other hand, since additional read and write operations are dispensed with.

An advantage of the block coder of FIGS. 3-8 consists in that, in particular, up to four—depending on the coding pass—coefficient bits placed one below the other within a stripe were modeled at the same time so as to generate information words which may possibly even contain compressed information for up to four bit/context pairs. Said information words are stored temporarily and are supplied, by suitable evaluation in a decoder, to the downstream arithmetic coder in a suitable representation and in the correct sequence in the above-described manner. By means of the above measures, coefficient bit modeling was improved such that it enables simplified hardware implementation.

As was described above, the bit extractor obtains, from a memory unit, a vector of coefficients so as to extract, from each coefficient k of the vector for the bit plane m to be coded, information which comprises the magnitude bit kₘ, the sign bit k_{vz} and status bits kₛₜ, the status bits in turn consisting of the bit which indicates whether the coefficient within the bit plane m is already significant, for which purpose a verification is performed, for all of the magnitude bits above the current plane, whether a bit has been set; if at least one bit has been set, the coefficient within said bit plane will be significant, and consisting of the bit which indicates whether the MR coding scheme has been applied to this coefficient for the first time or has already been applied previously, which is why verification is performed, for all of the magnitude bits above the current bit plane, whether one of said bits has been set, and if at least two bits have been set, the MR coding scheme has already been applied once to the coefficient. By means of said extraction, discrete status variables for each coefficient of a coding block may be dispensed with, as was mentioned above, since said information needs to be determined anew for each stripe and needs to be maintained only for the duration of the coding, as a result of which the appropriate memory size may be reduced, on the one hand, and the coding of the coding pass may be accelerated, on the other hand, since additional read and write operations are dispensed with.

Hardware implementation in accordance with FIGS. 3-8 therefore gives rise to expectations that in a clocked process at the same clock frequency, the coding of a coding pass may be performed substantially faster, since, as was mentioned above, the periods of waiting for register set operations are dispensed with, since up to four coefficients may be modeled at the same time, since up to five modeling operations may be performed in one step, since it is already known, at the beginning of the modeling operation of a column, how many coefficients may be modeled in one step, as a result of which time-consuming verification functions during modeling are dispensed with, and additional read and write operations for the status variables are dispensed with. These advantages are highly valuable for a compressor as is shown in FIG. 1, in which the coder of FIG. 3 may be employed. For it has already been found in several studies that the block coder and, above all, coefficient bit modeling, represents the costliest operation within the JPEG2000 coding process. In the article by Lian et al. which was already mentioned in the introduction to the description of the present application, a result of a study is presented, for example, according to which almost 52% of the computing power of a computer may be used for the sum of all of the three coding passes. Acceleration of the coefficient bit modeling operation thus has significant effects on the entire coding process. In implementations wherein a higher coding speed is achieved by multiple instantiation of the block coder, resources may thus be saved, so that, in the embodiment of FIGS. 3-8, fewer coding units may be used for achieving the same coding speed.

Implementations which have just been mentioned may be realized, for example, on FPGAs (field programmable logic arrays), but also as an integrated circuit, or ASIC (application specific integrated circuit). For an FPGA, a hardware implementation has already been put into practice, to which end the respective functional units were described by means of VHDL, were translated using suitable tools, and were synthesized for the target platform.

Various modifications may be performed on the embodiments of FIGS. 3-8. For example, the shift register 106 may be configured differently. In particular, it may comprise more shift register ranks, for example, i.e. it may be expanded toward the left-hand side in FIG. 8. In addition, the offset between the current vectors of 4 292, 322 and 506 may also be larger than the two shift register ranks, as is shown in FIG. 8. Also, it is possible for the offset to be variable. To this end, for example, the shift register unit is not configured in a uniform Manner, as is shown in FIG. 8, but is configured as two shift registers—one for the bit modeling unit 108₁, and a further one for the bit modeling units 108₂ and 108₃, a FIFO memory being arranged between them so as to serve as a variable buffer between the shift registers.

It was mentioned above that the sign bit precoding units establish, on the basis of the first control bits, whether or not the respective sign bits of the adjacent coefficients are known on the decoder side. Usually, the first control bit of the transformation coefficient which at the top adjoins the current coefficient in question is to be regarded as having been updated via the demultiplexer 214 or 414. However, should this result, because of signal run-time considerations, in that the processing cycles become delayed, it will also be possible for the sign bit precoding unit to virtually update a first control bit—which has not yet been updated—of the next adjacent coefficient up by means of the corresponding magnitude bit of said adjacent coefficient.

Also in order to simplify the representation, edge-related problems, such as at the edge of the bit planes, at the beginning or the end of a stripe, etc., have not been discussed in any detail above so as not to unnecessarily complicate the preceding description. Any data which is not present or is not available to the decoder may be adjusted to predetermined values in a manner which is advantageously known on the decoder side, as may be agreed. In addition, in the block coder of FIG. 3, the adjoining rows, respectively, of the adjoining stripes may be disregarded when coding the magnitude bits of the stripes. In this case, for example, the shift register, too, would be smaller, so as to comprise, in each of the parts 106₁ to 106₃, only the four rows of the stripes.

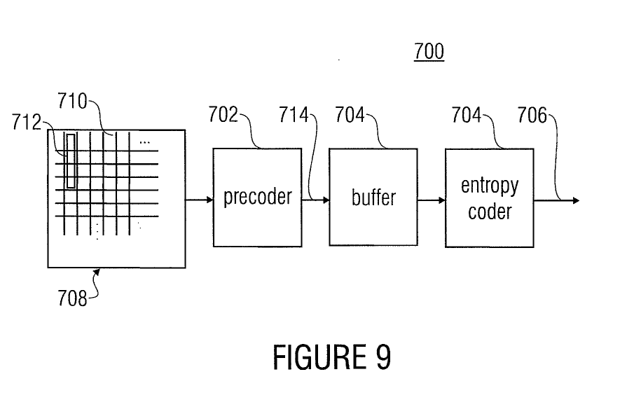

FIG. 9 shows a slightly more general example of a block coder. The block coder of FIG. 9, generally designated by 700, comprises a precoder 702, a buffer 704, and an entropy coder 706. The transformation coefficient block to be coded is illustrated at 708 in FIG. 9. Just like the bit modeling units explained above, the precoder 702 is configured to traverse the transformation coefficients 710, which are arranged in rows and columns, in tuples 712 belonging to four transformation coefficients 710 which here are adjacent in the column direction, by way of example. In particular, the precoder 702 is configured to traverse, bit plane by bit plane, the several magnitude bits by which the transformation coefficients 710 are represented to define several bit planes, so as to traverse, in particular, the magnitude bits in tuples 712 within each plane. In this context, the precoder 702 precodes predetermined ones of the magnitude bits, such as only the magnitude bits of significant transformation coefficients, as was the case in the bit modeling unit 108₂, or it precodes only the magnitude bits of insignificant transformation coefficients, as was the case in the bit modeling units 108₁ and 108₃. In this context, the precoder 702 precodes the predetermined magnitude bits such that it codes same, tuple by tuple, into a data word 714, i.e., in the exemplary case of FIG. 9, a maximum of four, or in a magnitude bit-by-magnitude bit manner, but, in this case, in such a manner that an associated sign is also coded into the data word 714 along with the magnitude bit.

Thus, the buffer 714 accommodates, in a very compressed form, a coding of the predetermined magnitude bits, possibly with associated signs. Conversely, the precoder may use only one operating clock, or one operating cycle, per data word, so that the traversing operation is fast.

The entropy coder is configured to obtain the data words from the buffer 704 in the order in which they were stored, and to subject them to entropy coding, it being possible for its processing speed to be independent of that of the precoder 702 on account of the temporary storage in the buffer 704, as long as the size of the buffer 704 is sufficient.

Naturally, the size of the tuple is not limited to four magnitude bits, and is also not limited to a column arrangement of the magnitude bits which are adjacent within the tuple 712. Even though in the embodiment of FIG. 9, only predetermined ones of the magnitude bits are captured by the precoder 702, and even though, therefore, a lossy compression of the transformation coefficient data is effected, a further pair of precoder and buffer may be connected in parallel to the pair of precoder 702 and buffer 704 by analogy with the preceding embodiment, so as to code further, other predetermined magnitude bits, in which case a decider may be provided in the entropy coder 706, similar to the entropy coding means 112, for coding the magnitude bits, which are precoded in the data words, into the data stream at the output of the entropy coder in a suitable sequence, possibly by means of sign bits. In accordance with a further modification, similar to the embodiment of FIG. 3, the precoder 702 may additionally or alternatively have a bit extractor and a shift register unit connected upstream from it, so that the precoder may operate on the basis of the information contained within this shift register unit, for example together with a precoder which is connected in parallel.

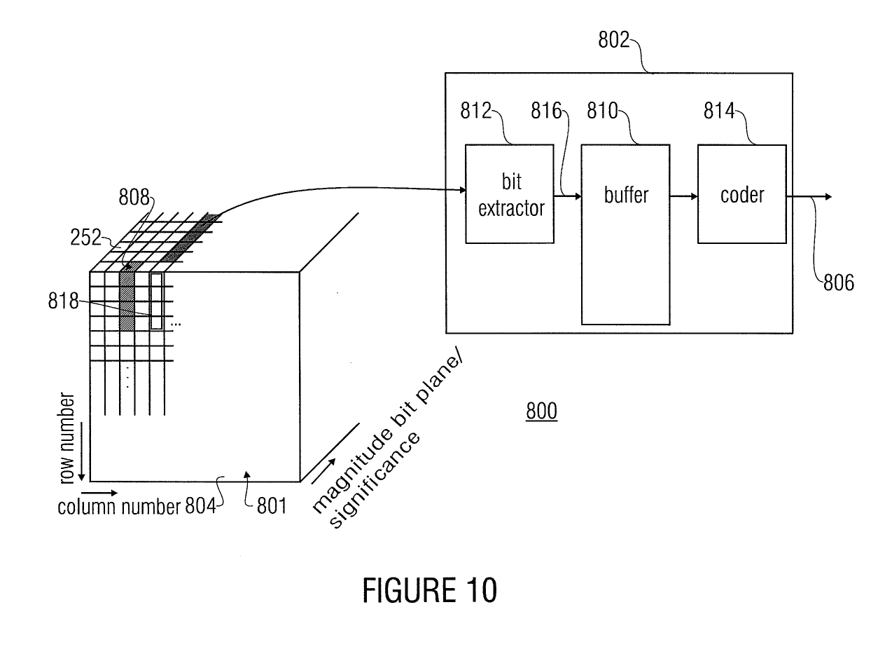

FIG. 10 shows a further, slightly more general example of a block coder. The block coder of FIG. 10, generally designated by 800, is provided, just like the preceding embodiment, for coding a block of transformation coefficients, each of which is represented by means of several magnitude bits which define a sequence of magnitude bit planes. In FIG. 10, these magnitude bits 252 are illustrated by identical reference numerals and an identical shape and arrangement, i.e. arranged as cubes in rows and columns and, in the depth, in magnitude bit planes, the resulting three-dimensional block 801 of magnitude bits 252 being shown in cross-section, so that its current magnitude bit plane 804 is visible, whereas those magnitude bit planes which have already been coded and are less significant are located further at the back, and the more significant bit planes are not visible. The block coder 800 comprises a coding means 802 provided for traversing the magnitude bits 252 magnitude bit plane by magnitude bit plane, specifically by traversing the respective current magnitude bit plane 802 individually in a predetermined sequence, or, as is depicted in FIG. 10 by way of example by analogy with the preceding embodiment, in tuples of adjacent magnitude bits 252. Within the current magnitude bit plane 802, the coding means codes, in the sequence of traversal, predetermined magnitude bits into a coded data stream 806. Traversing the magnitude bits 252 of the current magnitude bit plane 804 therefore takes place individually or tuple by tuple, as was the case in the preceding embodiment. In particular, a tuple currently to be coded is highlighted by hatching at 808 in FIG. 10.

The coding means 802 comprises a buffer 810, a bit extractor 812, and a coder 814, the bit extractor determining, during traversal of the magnitude bits 252, first status bits 816 which indicate—for the transformation coefficients which are represented by magnitude bits of the current magnitude bit plane 802 which are, at the earliest, to be processed next according to the pass sequence, and for which, by way of representation, potential magnitude bits are highlighted by a square 818 in FIG. 10—a significance in relation to the current magnitude bit plane 804. In particular, the bit extractor 812 determines these status bits from magnitude bits which represent the same transformation coefficients as the magnitude bits 818, but are situated within more significant bit planes than the former. With these first status bits 816, the bit extractor 812 continuously fills the memory storage 810, which temporarily stores said first status bits, mainly for as long as the first status bits may be used by the coder 814, i.e. may be accessible and updatable. For example, the buffer 810 may be configured as a FIFO memory. The coder 814 codes the predetermined ones among the magnitude bits 252 into the coded data stream 806 while using the first status bits in the buffer 810.

Even though the magnitude bit planes are traversed magnitude bit plane by magnitude bit plane, it is consequently not necessary that the first status bits for all of the transformation coefficients and, thus, across the entire coding of the individual magnitude bit planes, may be stored.

In the embodiment of FIG. 10, traversal of the magnitude bits of the current magnitude bit plane 104 is not limited to an approach of tuple-wise traversal. Rather, the magnitude bits 252 may also be traversed individually or in twos, etc. The buffer 810 may be provided, as in the preceding embodiments, for storing further information in addition to the first status bits. Examples are the temporary storage of magnitude bits 252 and/or associated sign bits and, possibly, second status bits. Even though in the embodiment of FIG. 10, only predetermined ones of the magnitude bits are captured by the coder 814, and, even though, therefore, lossy compression of the transformation coefficients is performed, a further coder may also be connected in parallel to the coder 814, by analogy with the preceding embodiment, so as to code further, other predetermined magnitude bits; in this case, a suitable entropy coding means comprising a multiplexer, or only a multiplexer/decider may be arranged downstream from said two coders so as to determine the sequence in which the various different predetermined magnitude bits are integrated into the coded data stream 806. Additionally or alternatively, a prediction means may also be connected between the buffer and the coder 814, said prediction means predicting, similar to the prediction units in the preceding embodiments, whether or not magnitude bits—which are not yet being processed—belong to the predetermined ones.

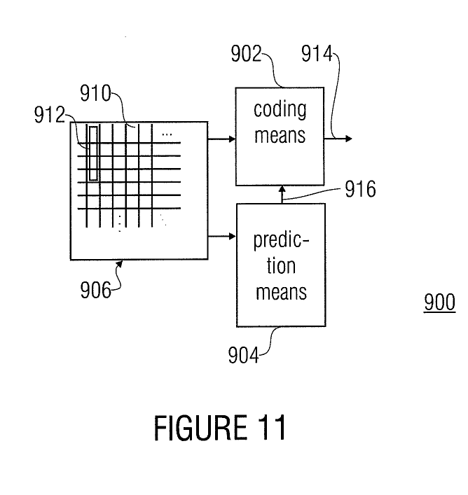

FIG. 11 shows a further, slightly more general example of a block coder. The block coder of FIG. 11, which is generally indicated by 900, comprises a coding means 902 and a prediction means 904. Both means 902 and 904 have access to the transformation coefficient block 906 to be coded. In this context, the coding means 902 is configured—just like the bit modeling units discussed above, in their interaction with the shift register unit 106, the bit extractor 104 and the adjoining arithmetic coding means 112—to traverse the transformation coefficients 910, which are arranged in columns and rows, in tuples 912 belonging to four transformation coefficients 910, respectively, which here are also adjacent in the column direction, by way of example. In particular, the coding means 902 is configured to traverse the several magnitude bits—which are represented by the transformation coefficients 910 to define several bit planes—bit plane by bit plane so as to traverse, in particular within each bit plane, the magnitude bits in tuples 902. In this context, the coding means 902 precodes predetermined ones of the magnitude bits, such as only the magnitude bits of significant transformation coefficients, as was the case in connection with the bit modeling unit 108₂, or only the magnitude bits of insignificant transformation coefficients, as was the case in connection with the bit modeling units 108₁ and 108₃. The predetermined magnitude bits are coded by the coding means 902 into a coded data stream 914, for example such that the order in which the predetermined magnitude bits are coded into the coded data stream 914 corresponds to the order of traversing the magnitude coefficients in the tuples 912, with the internal magnitude bit sequence within each tuple 912 being from top to bottom, for example, as was also the case, by way of example, in the preceding embodiments. The coding may, but does not have to, be an arithmetic coding, as was the case above. However, different entropy coding is also possible, such as Huffman coding, for example, or run-length coding, etc.

The prediction means 904 is configured to predict whether, and, if so, which of the magnitude bit(s) among the adjacent magnitude bits of the predetermined magnitude bit plane of a tuple that is, at the earliest, to be processed next according to a pass sequence, belong(s) to the predetermined magnitude bits. The coding means 902 uses this prediction result 916 to code the predetermined magnitude bits into the coded data stream in dependence on the prediction.

In this context, the coding means 902, in particular, may, for example, comprise, similarly to the magnitude bit precoding unit 202 of FIG. 4, a unit, e.g. a hard-wired unit, by means of which the coding means 902 is able to sequentially code, in the previously mentioned, specified sequence, selected ones of the magnitude bits within the current tuple 912. Since the prediction means 904 already provides its prediction result 916 in advance for a tuple before said tuple is currently to be processed by the coding means in a processing cycle, the coding means 902 may cause its sequentially operating coding circuit to sequentially process, without any clock delay, the predetermined magnitude bit(s) within the current tuple 912. This was also the case with the bit modeling units 108₁ and 108₃.

On the other hand, the coding means 902 may comprise, similarly to the magnitude bit precoding units 302₁₋₄ of FIG. 5, several coding units operating in parallel, so that the coding means 902 is able to process the several magnitude bits in the current tuple 912 in parallel in a processing cycle. In this case, however, the coding means 902 is able, on account of the prediction result 916, to prevent, in this very processing clock or processing cycle, that all of the magnitude bits of the current tuple enter into the coded data stream 914 in the sequence requested, but rather, with the parallel processing, the coding means 902 is able to take the membership of the individual magnitude bits of the current tuple into account such that only the predetermined magnitude bits are coded into the coded data stream, for which purpose the coding means 902 may be connected, in accordance with the preceding embodiment of the bit modeling unit 108₂, upstream from a buffer as a precoder, into which buffer the individual coding units or magnitude bit precoding units write their partial data words, which together form the data word of the respective precoder, and from which partial data words the subsequent entropy coding unit individually recognizes, for itself, from the individual partial data words, whether the respective partial data word belongs to a predetermined magnitude bit.

Of course, the size of the tuple is not limited to four magnitude bits and is not limited to a columnar arrangement of the magnitude bits which are adjacent in tuple 912. Even though, in the embodiment of FIG. 11, only predetermined ones of the magnitude bits are captured by the coding means 902, and even though, therefore, a lossy compression of the transformation coefficient data is performed, a further coding means may be connected in parallel, by analogy with the preceding embodiment of the coding means 902, so as to code further, other predetermined magnitude bits. If, e.g., a standard or the like should specify that the predetermined magnitude bits of the other coding means initially are to be coded into the coded data stream 914, and only after that the predetermined magnitude bits of the coding means 902, a decider which performs the respective integration into the data stream 914 may be connected downstream from the two coding means. In addition, the coding means 902 may, similarly to the previous embodiment, additionally or alternatively have a bit extractor or a shift register unit connected upstream from it, so that the coding means 902 may operate on the basis of the information contained within this shift register unit, for example together with the specified coding means which is connected in parallel.

The prediction means 904 performs its prediction on the basis of magnitude bit, for example, which are, at the earliest, currently being processed in the direction of traversing the magnitude bits in tuples. In this manner, the prediction means 904 is able to take into account that the significances which are also decisive for the prediction of the prediction means 904 may still change, for example, on account of the coding by the coding means 902. That is, in the event that the coding means 902 is configured—as were the bit modeling units above—to update the significance in the event that the coding means 902 codes a predetermined magnitude bit in the current tuple, which magnitude bit previously represented a non-significant transformation coefficient but within the current magnitude bit plane is 1, however—as a result of which this transformation coefficient now becomes significant within the current magnitude bit plane, however—the prediction means 904 may take into account, by evaluating corresponding magnitude bits, any cases which have not yet occurred of transformation coefficients becoming significant—which cases, however, are relevant to the prediction—by modifying the current significances. Similarly, the prediction means 904 may possibly also take into account, by evaluating the corresponding magnitude bits, that coding means which are connected in parallel still trigger events of becoming significant, which events might influence the prediction result of the coding means 902.

Depending on the conditions, any processes described in relation to transformation coefficient block coding may be configured not only in hardware, but naturally also in software. The implementation may be on a digital storage medium, for example a disc, a CD or a DVD with electronically readable control signals which may cooperate with a programmable computer system such that the corresponding method is performed. Generally, the invention thus also consists in a computer program product having a program code, stored on a machine-readable carrier, for performing any of the above methods, when the computer program product runs on a computer. In other words, the invention may thus be realized as a computer program having a program code for performing any of the above methods, when the computer program runs on a computer. In this context, a computer is understood to mean any form of a processor configured to execute a program or a program code, i.e., in particular, also a microcontroller or the like.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A device for coding a block of transformation coefficients, the transformation coefficients each being represented by means of several magnitude bits, so that same define a sequence of magnitude bit planes, comprising
a precoder for traversing the magnitude bits of a predetermined one of the magnitude bit planes in tuples of a plurality of adjacent magnitude bits in each case, and for coding predetermined ones of the magnitude bits of the tuples into data words such that a predetermined magnitude bit is coded, along with an associated sign bit, into one of the data words, or that a predetermined magnitude bit is coded, along with any other predetermined magnitude bit of the same tuple, into one of the data words, and coding other magnitude bits of the tuples, which are different from the predetermined magnitude bits, into further data words such that one of the other magnitude bits is coded into one of the further data words along with an associated sign bit, or that one of the other magnitude bits is coded into one of the further data words along with another one of the other magnitude bits of the same tuple;
a data word buffer for temporarily storing the data words;
a further data word buffer for temporarily storing the further data words; and
an entropy coder for coding the data words and the further data words from the data word buffer and the further data word buffer into a coded data stream, specifically by coding at first the data words in the buffer and then the further data words in the further buffer.

2. The device as claimed in claim 1, wherein the transformation coefficients are each represented by means of the several magnitude bits and a sign bit belonging to it, and wherein the precoder is configured such that coding of the predetermined magnitude bits also depends on the sign bit which belongs to this predetermined magnitude bit.

3. The device as claimed in claim 2, wherein the precoder is configured such that coding of the predetermined magnitude bits also depends on sign bits which belong to the magnitude bits which are adjacent to the predetermined magnitude bits.

4. The device as claimed in claim 3, wherein the precoder is configured such that coding of the predetermined magnitude bits also depends on first status bits, which indicate a significance, in relation to the predetermined magnitude bit plane, for the transformation coefficients which are represented by the predetermined magnitude bits and by magnitude bits which are adjacent to the predetermined magnitude bits.

5. A device for coding a block of transformation coefficients, the transformation coefficients each being represented by means of several magnitude bits so that same define a sequence of magnitude bit planes, comprising
a coder for traversing the magnitude bits of a predetermined one of the magnitude bit planes, and for coding predetermined ones of the magnitude bits into a coded data stream, the coder comprising:
a buffer;
a bit extractor for determining, while traversing the magnitude bits, first status bits which indicate a significance, in relation to the predetermined magnitude bit plane, for the transformation coefficients which are represented by magnitude bits of the predetermined magnitude bit plane which are, at the earliest, to be processed next according to a pass sequence, from magnitude bits which represent the same transformation coefficients as the magnitude bits which, at the earliest, are to be processed next, but are located within more significant bit planes than the former, and for filling the buffer with the first status bits determined; and
a coder for coding the predetermined magnitude bits into the coded data stream while using the first status bits in the buffer,
wherein the buffer is configured such that at any time, it stores the first status bits for only a section of the transformation coefficients, and wherein the coder is configured to traverse a less significant magnitude bit plane upon traversing the predetermined magnitude bit plane, and to code the predetermined magnitude bits of the less significant magnitude bit plane into the data stream, specifically while determining the first status bits and while filling the buffer by the bit extractor.

6. The device as claimed in claim 5, wherein the bit extractor and the coder are configured such that the first status bits, with which the bit extractor fills the buffer, indicate the significance for transformation coefficients which are represented by magnitude bits of the current magnitude bit plane which are processed by the coder with a constant offset according to the pass sequence, so as to code the predetermined magnitude bits among the magnitude bits of the current magnitude bit plane.

7. The device as claimed in claim 5, wherein the buffer is configured as a shift register, wherein the bit extractor is configured to fill the shift register at a front end of same, and wherein the coder is configured to perform the coding of the predetermined magnitude bits into the coded data stream at least also while using register contents of the shift register which are located at least one shift rank behind the front end of the shift register, and to also perform, during a course of the coding, an update of register contents of the shift register which are located at least one shift rank before the register contents which are used for coding.

8. The device as claimed in claim 7, wherein the coding is configured to traverse the magnitude bits of the predetermined magnitude bit plane in tuples of a plurality of adjacent magnitude bits in each case, and wherein the coder comprises:
a precoder for coding, while traversing the magnitude bits, predetermined ones of the magnitude bits of the tuples into data words such that a predetermined magnitude bit is coded, together with an associated sign bit, into one of the data words, or that a predetermined magnitude bit is coded, together with another predetermined magnitude bit of the same tuple, into one of the data words;
a data word buffer for temporarily storing the data words; and
an entropy coder for coding the data words from the data word buffer into the coded data stream.

9. The device as claimed in claim 8, wherein the transformation coefficients are each represented by means of the several magnitude bits and by an associated sign bit, and wherein the precoder is configured such that the coding of the predetermined magnitude bits also depends on the sign bit which belongs to said predetermined magnitude bit.

10. The device as claimed in claim 9, wherein the precoder is configured such that the coding of the predetermined magnitude bits also depends on sign bits which belong to those magnitude bits which are adjacent to the predetermined magnitude bits.

11. The device as claimed in claim 10, wherein the precoder is configured such that the coding of the predetermined magnitude bits also depends on first status bits which indicate a significance, in relation to the predetermined magnitude bit plane, for the transformation coefficients which are represented by the predetermined magnitude bits and by magnitude bits which are adjacent to the predetermined magnitude bits.

12. A device for coding a block of transformation coefficients, the transformation coefficients each being represented by means of several magnitude bits, so that same define a sequence of magnitude bit planes, comprising
a coder for traversing the magnitude bits of a predetermined one of the magnitude bit planes in tuples of a plurality of adjacent magnitude bits of the predetermined magnitude bit plane in each case, and for coding the magnitude bits of the tuples into a coded data stream, the magnitude bits belonging to first, second and third passes, respectively; and
a predictor for predicting whether, and, if so, which of the magnitude bit(s) among the adjacent magnitude bits of the predetermined magnitude bit plane of a tuple that is, at the earliest, to be processed next according to a pass sequence, belong(s) to which of said first, second and third passes,
said coding unit comprising a precoder for each of the passes, said precoders being configured to code, during traversal, those magnitude bits from the tuple currently being processed which belong to the respective pass;
for each of the precoders, a buffer for temporarily storing the data words of the respective precoder; and
an entropy coder configured to code the data words in the buffers in the order of the passes,
each precoder
being configured to serially code a selection of the magnitude bits of the tuple currently being processed into the coded data stream and to adjust the selection on the basis of the prediction,
or
being configured to code the magnitude bits of the tuple currently being processed into partial data words by means of parallel processing, said partial data words forming a data word of the respective precoder and comprising an admissible state or an inadmissible state, depending on the prediction, so that it may be determined exclusively by means of the data word which of the partial data words have been produced for magnitude bits which belong to the magnitude bits of the respective pass.

13. The device as claimed in claim 12, wherein the predictor is configured to perform the prediction on the basis of magnitude bits of the predetermined magnitude bit plane in tuples which, according to the pass sequence, are to be processed later than a tuple which was the most recent one to be processed.

14. The device as claimed in claim 12, wherein the predictor is configured to modify status information—on the basis of magnitude bits of the predetermined magnitude bit plane in tuples which, according to the sequence, are to be processed later than a tuple which was the most recent one to be processed, said status information indicating a significance, in relation to the predetermined magnitude bit plane, for the transformation coefficients which are represented by the magnitude bits of the predetermined magnitude bit plane of the tuples to be processed later, so as to make the prediction on the basis of the modified significance information.

15. The device as claimed in claim 1, wherein the precoder comprises a buffer and a bit extractor for filling the buffer, while the magnitude bits in tuples are traversed, comprising
a tuple of a plurality of adjacent magnitude bits of the predetermined magnitude bit plane, which tuple is, at the earliest, to be processed next according to a pass sequence,
sign bits which belong to the magnitude bits of the tuple which is, at the earliest, to be processed next, and
first status bits which indicate a significance, in relation to the predetermined magnitude bit plane, for the transformation coefficients which are represented by a plurality of adjacent magnitude bits of the predetermined magnitude bit plane of a tuple which, at the earliest, is to be processed after the next one according to the pass sequence,
connected upstream from it, and wherein the precoder is configured to perform the coding on the basis of a content of the buffer.

16. The device as claimed in claim 15, wherein the bit extractor is configured to determine, for filling the buffer, the first status bits from magnitude bits which represent the same transformation coefficients as the magnitude bits of the tuple to be processed, at the earliest, after the next one, but which are located within more significant magnitude bit planes than the former.

17. The device as claimed in claim 15, wherein the bit extractor is configured to acquire, for filling the buffer, the plurality of adjacent magnitude bits of the tuple which is, at the earliest, to be coded next, and the sign bits belonging to them by means of a memory access to a memory which stores the magnitude bits and sign bits.

18. The device as claimed in claim 16, wherein the buffer comprises a shift register which loses first status bits, with which the buffer is filled, not until after more than five shifting operations, and/or which loses magnitude bits, with which the buffer is filled, not until after more than three shifting operations, and/or which loses sign bits, with which the buffer is filled, not until after more than four shifting operations.

19. The device as claimed in claim 4, wherein the precoder comprises
a magnitude bit precoding unit configured to generate, on the basis of
a supplied magnitude bit among the adjacent magnitude bits of a tuple currently being processed according to a pass sequence, and
first status bits for the transformation coefficients which are represented by a first plurality of magnitude bits of the predetermined magnitude bit plane which are adjacent to the supplied magnitude bit,
a first partial data word from which the supplied magnitude bit and an associated magnitude bit context may be determined, and
a sign bit precoding unit configured to generate, on the basis of
the sign bit which belongs to the supplied magnitude bit;
sign bits which belong to a second plurality of magnitude bits of the predetermined magnitude bit plane which are adjacent to the magnitude bit supplied; and
the first status bits for the transformation coefficients which are represented by the second plurality of magnitude bits of the predetermined magnitude bit plane,
a second partial data word from which the sign bit which belongs to the supplied magnitude bit, and an associated sign bit context may be determined,
the precoder being configured such that the data word of the supplied magnitude bit comprises the first partial data word and the second partial data word, and
wherein the entropy coder is configured to determine, from the first partial data word, the supplied magnitude bit and the associated magnitude bit context, and to arithmetically code the supplied magnitude bit into the data stream in a context-dependent manner while using the supplied magnitude bit context, and, if the magnitude bit supplied is significant, to determine, from the second partial data word, the sign bit belonging to the supplied magnitude bit and the sign bit context belonging to same, and to arithmetically code the sign bit belonging to the supplied magnitude bit into the data stream in a context-dependent manner while using the associated sign bit context.

20. The apparatus as claimed in claim 19, wherein the precoder comprises
a multiplex circuit, comprising
a first multiplexer circuit to which any of the magnitude bits of the tuple currently being processed may be indicated by means of a control signal, and which is configured to supply the magnitude bit indicated to the magnitude bit precoding unit as the supplied magnitude bit;
a second multiplexer circuit, which may be controlled by the control signal to supply the first status bits for transformation coefficients which are represented by a third plurality of magnitude bits of the predetermined magnitude bit plane, which are adjacent to the indicated magnitude bit, to the magnitude bit precoding unit as the first control bits for the transformation coefficients which are represented by the first plurality of magnitude bits, and to supply the first status bits for transformation coefficients which are represented by a fourth plurality of magnitude bits of the predetermined magnitude bit plane, which are adjacent to the magnitude bit indicated, to the sign bit precoding unit as the first control bits for the transformation coefficients which are represented by the second plurality of magnitude bits;
a third multiplexer unit which may be controlled by the control signal to supply the sign bits, which belong to the indicated magnitude bit and to the fourth plurality of magnitude bits of the predetermined magnitude bit plane, to the sign bit precodinq unit as the sign bit which belongs to the predefined magnitude bit, and the sign bits belonging to the second plurality of magnitude bits.

21. The device as claimed in claim 4, wherein the precoder comprises a
predictor for predicting whether, and, if so, which of the magnitude bits among the adjacent magnitude bits of the predetermined magnitude bit plane of a tuple which is to be processed next according to the pass sequence belongs to the predetermined magnitude bits, the predictor being configured to make the prediction on the basis of the magnitude bits of the predetermined magnitude bit plane of the tuple which is to be processed next and the tuple which is currently being processed, and of the first status bits for the transformation coefficients which are represented by the magnitude bits of the predetermined magnitude bit plane of the tuple to be processed next, of the tuple currently being processed, and of the tuple to be processed after the next one.

22. The device as claimed in claim 21, wherein the predictor is configured such that the prediction whether, and, if so, which of the magnitude bits among the adjacent magnitude bits of the predetermined magnitude bit plane of a tuple to be processed next according to the pass sequence belongs to the predetermined magnitude bits, also depends on a previous prediction by the predictor as to whether, and, if so, which of the magnitude bits among the adjacent magnitude bits of the predetermined magnitude bit plane of a tuple currently being processed according to the pass sequence belongs to the predetermined magnitude bit.

23. The device as claimed in claim 21, wherein the predictor is configured such that the prediction whether, and, if so, which of the magnitude bits among the adjacent magnitude bits of the predetermined magnitude bit plane of a tuple to be processed next according to the pass sequence belongs to the predetermined magnitude bit, also depends on first status bits for the transformation coefficients which are represented by the magnitude bits of the predetermined magnitude bit plane of the tuple which was the most recent one to be processed according to the pass sequence.

24. The device as claimed in claim 21, wherein the predictor is configured to output a result of the prediction in the form of a bit vector which comprises a vector bit per magnitude bit of the tuple to be processed next, said vector bit indicating the membership or non-membership of the respective magnitude bit of the tuple to be processed next.

25. The device as claimed in claim 21, wherein the precoder further comprises a shift pulse generator configured to predict—on the basis of the magnitude bits of the predetermined magnitude bit planes of the tuple to be processed next and of the tuple currently being processed, and of the first control bits for transformation coefficients which are represented by magnitude bits of the predetermined magnitude bit plane of the tuple to be processed next, of the tuple currently being processed and of the tuple to be processed after the next one—how many of the magnitude bits among the adjacent magnitude bits of the predetermined magnitude bit plane of the tuple to be processed next belong to the predetermined magnitude bits, and to output a shift pulse to a shift register on the basis of the predicted number and of a processing clock, in units of which the coding of the predetermined magnitude bits into data words is performed, delayed by no, one or several clock cycles of the processing clock.

26. The device as claimed in claim 4, wherein the precoder further comprises a multiplexer controller configured to output, to a multiplexer circuit, a control signal which sequentially indicates, in a predetermined sequence, those magnitude bits among the adjacent magnitude bits of a tuple currently being processed which belong to the predetermined magnitude bits.

27. The device as claimed in claim 1, wherein the precoder is configured to also generate, during a pass, one data word, respectively, for tuples, non of the adjacent magnitude bits of which belongs to the predetermined magnitude bits, and to set a validity bit in dependence of whether the magnitude bits in a tuple currently being processed according to the pass sequence comprise a predetermined magnitude bit, and wherein the data word buffer is configured to temporarily store the respective data word only in the event that a validity bit has been set, or when the respective data word for the last tuple in the predetermined magnitude bit plane has been generated.

28. The device as claimed in claim 1, wherein the precoder is configured such that the magnitude bits of the predetermined magnitude bit plane are traversed stripe by stripe, such that the adjacent bits of each tuple are located within a column of the block, and that directly successive tuples are located adjacent to one another column to column or in directly adjacent stripes or rows of the block, with one of the two tuples at one end of one of the immediately adjacent stripes and the other of the two tuples at an opposite end of the other of the directly adjacent stripes.

29. The device as claimed in claim 1, wherein the precoder is configured such that it traverses a less significant magnitude bit plane upon traversing the predetermined magnitude bit plane, and that it codes the predetermined magnitude bits of the less significant magnitude bit plane into data words.

30. The device as claimed in claim 1, wherein the precoder is configured such that it adjusts, for each predetermined magnitude bit, a bypass mode bit of the respective data word in dependence on a bit depth associated with the predetermined magnitude bit plane.

31. The device as claimed in claim 4, wherein the precoder is configured such that coding of each tuple of a plurality of adjacent magnitude bits also depends on first status bits which indicate a significance, in relation to the predetermined magnitude bit plane, for the transformation coefficients which are represented by the predetermined magnitude bits and by magnitude bits which are adjacent to the predetermined magnitude bits, and on second status bits which indicate, for the transformation coefficients represented by predetermined magnitude bits, whether among the magnitude bits which represent the respective transformation coefficients and are located within more significant magnitude bit planes than the predetermined magnitude bit plane, there exist two or more than two magnitude bits for the respective transformation coefficient which are significant.

32. The device as claimed in claim 31, wherein the precoder comprises, per magnitude bit of the plurality of adjacent magnitude bits of the tuples,
a magnitude bit precoding unit configured to generate, on the basis of
the respective magnitude bit among the adjacent magnitude bits of a tuple currently being processed according to a pass sequence,
the first status bits for the transformation coefficients which are represented by a seventh plurality of magnitude bits of the predetermined magnitude bit plane which are adjacent to the respective magnitude bit, and
the second status bit for the transformation coefficient which is represented by the respective magnitude bit,
a respective partial data word from which the respective magnitude bit and an associated magnitude bit context may be determined, and
and wherein the precoder is configured such that the partial data words jointly yield the data word of the predetermined data bit(s) of the tuple currently being processed, and that it may be determined exclusively by means of the data word which of the partial data words have been generated for magnitude bits which belong to the predetermined magnitude bits,
the entropy coder being configured to determine, from the partial data words, which of same have been generated for magnitude bits which belong to the predetermined magnitude bits, and to determine therefrom the respective magnitude bit and the associated magnitude bit context, and to arithmetically code the respective magnitude bit into the data stream in a context-dependent manner while using the associated magnitude bit context.

33. The device as claimed in claim 32, wherein the precoder comprises a
predictor for predicting whether, and, if so, which of the magnitude bit(s) among the adjacent magnitude bits of the predetermined magnitude bit plane of a tuple which, at the earliest, is to be processed after the next one according to the pass sequence belong(s) to the predetermined magnitude bits, the predictor being configured to make the prediction on the basis of the first status bits for the transformation coefficients which are represented by the magnitude bits of the predetermined magnitude bit plane of a tuple which, at the earliest, is to be processed after the next one.

34. The device as claimed in claim 21, wherein the precoder comprises
a run-length coding unit which generates, on the basis of a prediction result of the predictor in the state wherein the tuple to be processed next is starting to be processed, a run-length partial data word from which it may be determined how many of the magnitude bits of the tuples starting to be processed in a predetermined magnitude bit sequence among same are continually insignificant, and—if one of the magnitude bits of the tuple starting to be processed exists which is significant and is not the first magnitude bit in this tuple in the magnitude bit sequence—at which position the first significant magnitude bit in the magnitude bit sequence is located,
a coefficient selector unit configured to output, on the basis of a prediction result of the predictor in the state wherein the tuple to be processed next is starting to be processed, a control signal which sequentially specifies, in the magnitude bit sequence, the first significant magnitude bit in the magnitude bit sequence, and the magnitude bits which follow said first significant magnitude bit in the magnitude bit sequence of the tuple starting to be processed, and
a magnitude bit precoding unit configured to generate, in dependence on the control signal, in each case on the basis of
a respectively predefined magnitude bit among the adjacent magnitude bits of the tuple starting to be processed, and
first status bits for the transformation coefficients which are represented by a first plurality of magnitude bits of the predetermined magnitude bit plane which are adjacent to the respectively predefined magnitude bit,
a first partial data word from which the respectively predefined magnitude bit and an associated magnitude bit context may be determined, and
a sign bit precodinq unit configured to generate, depending on the control signal and on the basis of
the sign bit which belongs to the respectively predefined magnitude bit;
sign bits which belong to a second plurality of magnitude bits of the predetermined magnitude bit plane which are adjacent to the respectively predefined magnitude bit; and
the first status bits for the transformation coefficients which are represented by the second plurality of magnitude bits of the predetermined magnitude bit plane,
a second partial data word from which the sign bit which belongs to the respectively predefined magnitude bit, and an associated sign bit context may be determined,
and wherein the precoder is configured such that one of the data words comprises the first partial data word, the second partial data word and the run-length data word, and the entropy coder being configured to determine, from the run-length data word, information about the magnitude bits which are continually insignificant in the predetermined magnitude bit sequence, and to arithmetically code them into the data stream, to determine, from the first partial data word—except for the case of the first significant magnitude bit in the magnitude bit sequence—the magnitude bit which is predefined in each case, and the associated magnitude bit context, and to arithmetically code the respectively predefined magnitude bit into the data stream in a context-dependent manner while using the supplied magnitude bit context, and, if the respectively predefined magnitude bit is significant, to determine the sign bit belonging to the respectively predefined magnitude bit and the sign bit context belonging to same from the second partial data word—even in the case of the first significant magnitude bit in the magnitude bit sequence—and to arithmetically code the sign bit which belongs to the respectively predefined magnitude bit into the data stream in a context-dependent manner while using the associated sign bit context.

35. The device as claimed in claim 1, wherein the precoder is further configured to code, during a pass, other magnitude bits of the tuple, which are different from the predetermined magnitude bits, into further data words such that one of the other magnitude bits is coded into one of the data words along with an associated sign bit, or that one of the other magnitude bits is coded into one of the data words along with another one of the other magnitude bits of the same tuple, the device further comprising a further buffer for temporarily storing the further data words, and the entropy coder being configured to initially code the data words within the buffer and then the further data words within the further buffer into the coded data stream.

36. A method of coding a block of transformation coefficients, the transformation coefficients each being represented by means of several magnitude bits, so that same define a sequence of magnitude bit planes, the method comprising:
traversing the magnitude bits of a predetermined one of the magnitude bit planes in tuples of a plurality of adjacent magnitude bits in each case, and for coding predetermined ones of the magnitude bits of the tuples into data words such that a predetermined magnitude bit is coded, along with an associated sign bit, into one of the data words, or that a predetermined magnitude bit is coded, along with any other predetermined magnitude bit of the same tuple, into one of the data words, and coding other magnitude bits of the tuples, which are different from the predetermined magnitude bits, into further data words such that one of the other magnitude bits is coded into one of the further data words along with an associated sign bit, or that one of the other magnitude bits is coded into one of the further data words along with another one of the other magnitude bits of the same tuple;
temporarily storing the data words in a data word buffer;
temporarily storing the further data words in a further data word buffer; and
coding the temporarily stored data words and the further data words from the data word buffer and the further data word buffer into a coded data stream, specifically by coding at first the data words in the buffer and then the further data words in the further buffer.

37. A method of coding a block of transformation coefficients, the transformation coefficients each being represented by means of several magnitude bits so that same define a sequence of magnitude bit planes, the method comprising:
traversing the magnitude bits of a predetermined one of the magnitude bit planes, and for coding predetermined ones of the magnitude bits into a coded data stream while performing the following:
determining, while traversing the magnitude bits, first status bits which indicate a significance, in relation to the predetermined magnitude bit plane, for the transformation coefficients which are represented by magnitude bits of the predetermined magnitude bit plane which are, at the earliest, to be processed next according to a pass sequence, from magnitude bits which represent the same transformation coefficients as the magnitude bits which, at the earliest, are to be processed next, but are located within more significant bit planes than the former;
filling a buffer with the first status bits determined; and
coding the predetermined magnitude bits into the coded data stream while using the first status bits in the buffer,
wherein the buffer is configured such that at any time, it stores the first status bits for only a section of the transformation coefficients, and wherein upon traversal of the predetermined magnitude bit plane, a less significant magnitude bit plane is traversed, specifically while coding the predetermined magnitude bits of the less significant magnitude bit plane into the data stream, while re-determining the first status bits, and while refilling the buffer.

38. A method of coding a block of transformation coefficients, the transformation coefficients each being represented by means of several magnitude bits, so that same define a sequence of magnitude bit planes, the method comprising:
traversing the magnitude bits of a predetermined one of the magnitude bit planes in tuples of a plurality of adjacent magnitude bits of the predetermined magnitude bit plane in each case while coding the magnitude bits of the tuples into a coded data stream, the magnitude bits each belonging to one of a first, second and third pass, a precoding for each of the passes being used for coding, said precodinq taking place so as to code, during traversal, the magnitude bits from the tuple currently being processed which belong to the respective pass into data words;
predicting whether, and, if so, which of the magnitude bit(s) among the adjacent magnitude bits of the predetermined magnitude bit plane of a tuple which, at the earliest, is to be processed next according to a pass sequence belong(s) to which pass;
temporarily storing the data words of the respective precoder in a respective buffer; and
entropy coding the data words in the buffers in the sequence of the passes,
wherein for each pass
within the context of the respective precodinq, a selection of the magnitude bits of the tuple currently being processed is serially coded into the coded data stream, and the selection is adjusted on the basis of the prediction,
or
within the context of the respective precoding, the magnitude bits of the tuple currently being processed are coded, by means of parallel processing, into partial data words which form a data word of the respective precoder and comprise an admissible state or an inadmissible state, depending on the prediction, so that it may be determined exclusively by means of the data word which of the partial data words have been produced for magnitude bits which belong to the magnitude bits of the respective pass.

39. A program comprising a program code for performing the method of coding a block of transformation coefficients, the transformation coefficients each being represented by means of several magnitude bits, so that same define a sequence of magnitude bit planes, the method comprising:
traversing the magnitude bits of a predetermined one of the magnitude bit planes in tuples of a plurality of adjacent magnitude bits in each case, and for coding predetermined ones of the magnitude bits of the tuples into data words such that a predetermined magnitude bit is coded, along with an associated sign bit, into one of the data words, or that a predetermined magnitude bit is coded, along with any other predetermined magnitude bit of the same tuple, into one of the data words, and coding other magnitude bits of the tuples, which are different from the predetermined magnitude bits, into further data words such that one of the other magnitude bits is coded into one of the further data words along with an associated sign bit, or that one of the other magnitude bits is coded into one of the further data words along with another one of the other magnitude bits of the same tuple;
temporarily storing the data words in a data word buffer;
temporarily storing the further data words in a further data word buffer; and
coding the temporarily stored data words and the further data words from the data word buffer and the further data word buffer into a coded data stream, specifically by coding at first the data words in the buffer and then the further data words in the further buffer,
when the program runs on a processor.

40-45. (canceled)
